(19) United States
(12) Patent Application Publication
(10) Pub. No.: US 2025/0211019 A1
(43) Pub. Date: Jun. 26, 2025

(54) CIRCUIT FOR DISCHARGING A CAPACITOR USING POWER TRANSISTORS OPERATING IN NON-LINEAR MODE

(71) Applicant: Infineon Technologies AG, Neubiberg (DE)

(72) Inventors: Tomas Manuel Reiter, Ottobrun (DE); Michael Krug, Munich (DE)

(21) Appl. No.: 18/392,167

(22) Filed: Dec. 21, 2023

(51) Int. Cl. H02J 7/34; H02J 7/00

(52) U.S. Cl. CPC H02J 7/345; H02J 7/007182; H02J 2207/20

(57) ABSTRACT

A circuit includes a first power transistor and a second power transistor. The circuit also includes a controller configured to control the first power transistor to perform a sequence of first switching cycles by applying, for each switching cycle of the sequence of first switching cycles, a first gate voltage exceeding a threshold gate voltage so that the first power transistor operates according to a non-linear transfer function. The controller is also configured to control the second power transistor to perform a sequence of second switching cycles by applying, for each switching cycle of the sequence of second switching cycles, a second gate voltage exceeding the threshold gate voltage so that the second power transistor operates according to the non-linear transfer function. The controller is configured to cause the capacitor to discharge according to a sequence of discharge phases.

### TECHNICAL FIELD

This disclosure relates to semiconductor devices such as power transistors.

### BACKGROUND

Electrical components may draw power from an electric power source, such as a battery. For example, an electric vehicle may include one or more electric motors, an air conditioning and heating unit, and other electrical components that draw power. A direct current (DC) link capacitor may be located between the power source and one or more electrical components that draw power. When the DC link capacitor is charged, the DC link capacitor may protect the one or more electrical components from voltage spikes resulting from large current variations. Current variations may cause a voltage spike when an amount of power drawn by a load changes by a large amount in a short period of time. A DC link capacitor may be charged to a high voltage. This means that it may be beneficial to discharge the DC link capacitors in some cases.

### SUMMARY

In general, this disclosure is directed to a circuit including power transistors configured to discharge a direct current (DC) link capacitor within a period of time. For example, the circuit may include a first power transistor and a second power transistor connected in series with the first power transistor. The DC link capacitor may be connected to the first power transistor such that the DC link capacitor is configured to discharge through the first power transistor and the second power transistor. That is, when DC link capacitor discharges, electrical current may flow through the first power transistor and the second power transistor via a discharge current pathway. As the electrical current flows from the DC link capacitor via the discharge current pathway, a voltage of the DC link capacitor decreases.

A controller may control the first power transistor to perform a sequence of first switching cycles and control the second power transistor to perform a sequence of second switching cycles. A switching cycle may include an activation phase when the power transistor is turned on and a deactivation phase when the power transistor is turned off. When both of the first power transistor and the second power transistor are turned on in the activation phase, electrical current may flow from the capacitor through the first power transistor and the second power transistor via the discharge current pathway. The controller may control the sequence of first switching cycles and the sequence of second switching cycles so that there are one or more periods of overlap between activation phases of the sequence of first switching cycles and activation phases of the sequence of second switching cycles.

Additionally, or alternatively, electrical current may flow from the capacitor through the discharge current pathway via parasitic capacitances of the first power transistor and the second power transistor. For example, electrical current from the DC link capacitor may charge a parasitic capacitance of the first power transistor, the parasitic capacitance of the first power transistor may discharge to charge the parasitic capacitance of the second power transistor, and the parasitic capacitance of the second power transistor may discharge through the discharge current pathway. Electrical current may discharge through the discharge current pathway via parasitic capacitances of the first power transistor and the second power transistor even when activation phases of the sequence of first switching cycles and the sequence of second switching cycles do not overlap or overlap for very short periods of time. This means that the controller may control the sequence of first switching cycles the sequence of second switching cycles to discharge the DC link capacitor without applying stress to the first power transistor and the second power transistor associated with overlapping activation phases.

The first power transistor and the second power transistor may operate in a non-linear mode. In the non-linear mode, there is a non-linear relationship between a voltage applied to a gate terminal of the power transistor and an electrical current flowing through the power transistor. On the other hand, a power transistor operates in linear mode when there is a linear relationship between the voltage applied to the gate terminal of a power transistor and the electrical current flowing through the power transistor. It may be beneficial for the first power transistor and the second power transistor to operate in the non-linear mode when discharging the DC link capacitor. By causing the first power transistor and the second power transistor to operate in the non-linear mode, the controller may discharge the DC link capacitor without precisely controlling voltage applied to the gate terminals of the first power transistor and the second power transistor to control the magnitude of the current flowing through the discharge current pathway.

The techniques of this disclosure may provide one or more advantages. For example, by using a first power transistor and a second power transistor connected in series, the controller may discharge the DC link capacitor within a period of time. The controller may cause the first power transistor to perform a sequence of first switching cycles and control the second power transistor to perform a sequence of second switching cycles. The sequence of first switching cycles and the sequence of second switching cycles may cause the DC link capacitor to discharge according to a sequence of discharge phases. This means that the controller may control the DC link capacitor to discharge by applying less stress to the first power transistor and the second power transistor as compared with systems that do not control power transistors to discharge a DC link capacitor according to a sequence of discharge phases.

In some examples, a circuit includes a first power transistor comprising a first gate terminal and a second power transistor includes a second gate terminal. The second power transistor is connected in series with the first power transistor. A capacitor, the first power transistor, and the second power transistor are located on a discharge current pathway. The circuit also includes a controller configured to control the first power transistor to perform a sequence of first switching cycles by applying, for each switching cycle of the sequence of first switching cycles, a first gate voltage to the first gate terminal, the first gate voltage exceeding a threshold gate voltage so that the first power transistor operates according to a non-linear transfer function and control the second power transistor to perform a sequence of second switching cycles by applying, for each switching cycle of the sequence of second switching cycles, a second gate voltage to the second gate terminal, the second gate voltage exceeding the threshold gate voltage so that the second power transistor operates according to the non-linear transfer function. By controlling the first power transistor to perform the sequence of first switching cycles and controlling the second power transistor to perform the sequence of second switching cycles, the controller is configured to cause the capacitor to discharge according to a sequence of discharge phases via the discharge current pathway.

In some examples, a method includes controlling, by a controller, a first power transistor comprising a first gate terminal to perform a sequence of first switching cycles by applying, for each switching cycle of the sequence of first switching cycles, a first gate voltage to the first gate terminal, the first gate voltage exceeding a threshold gate voltage so that the first power transistor operates according to a non-linear transfer function; and controlling, by the controller, a second power transistor comprising a second gate terminal to perform a sequence of second switching cycles by applying, for each switching cycle of the sequence of second switching cycles, a second gate voltage to the second gate terminal, the second gate voltage exceeding the threshold gate voltage so that the second power transistor operates according to the non-linear transfer function, wherein the second power transistor is connected in series with the first power transistor, and wherein a capacitor, the first power transistor, and the second power transistor are located on a discharge current pathway. By controlling the first power transistor to perform the sequence of first switching cycles and controlling the second power transistor to perform the sequence of second switching cycles, the method comprises causing the capacitor to discharge according to a sequence of discharge phases via the discharge current pathway.

In some examples, a system includes a capacitor, a first power transistor comprising a first gate terminal, and a second power transistor comprising a second gate terminal. The second power transistor is connected in series with the first power transistor. The capacitor, the first power transistor, and the second power transistor are located on a discharge current pathway. The system also includes a controller configured to: control the first power transistor to perform a sequence of first switching cycles by applying, for each switching cycle of the sequence of first switching cycles, a first gate voltage to the first gate terminal, the first gate voltage exceeding a threshold gate voltage so that the first power transistor operates according to a non-linear transfer function; and control the second power transistor to perform a sequence of second switching cycles by applying, for each switching cycle of the sequence of second switching cycles, a second gate voltage to the second gate terminal, the second gate voltage exceeding the threshold gate voltage so that the second power transistor operates according to the non-linear transfer function. By controlling the first power transistor to perform the sequence of first switching cycles and controlling the second power transistor to perform the sequence of second switching cycles, the system is configured to cause the capacitor to discharge according to a sequence of discharge phases via the discharge current pathway.

The details of one or more embodiments of this disclosure are set forth in the accompanying drawings and the description below. Other features, objects, and advantages will be apparent from the description and drawings, and from the claims.

### BRIEF DESCRIPTION OF THE DRAWINGS

FIG. 1 is a block diagram illustrating a system for discharging a direct current (DC) link capacitor, in accordance with this disclosure.

FIG. 2 is a circuit diagram illustrating a system for discharging a DC link capacitor through a discharge current pathway across a first power transistor and a second power transistor, in accordance with this disclosure.

FIG. 3 is a plot diagram illustrating a first timeseries plot of a sequence of first switching cycles, a sequence of second switching cycles, and a sequence of discharge phases, in accordance with this disclosure.

FIG. 4 is a plot diagram illustrating a second timeseries plot of a sequence of first switching cycles, a sequence of second switching cycles, and a sequence of discharge phases, in accordance with this disclosure.

FIG. 5 is a plot diagram illustrating a third timeseries plot of a sequence of first switching cycles, a sequence of second switching cycles, and a sequence of discharge phases, in accordance with this disclosure.

FIG. 6 is a plot diagram illustrating a fourth timeseries plot of a sequence of first switching cycles, a sequence of second switching cycles, and a sequence of discharge phases, in accordance with this disclosure.

FIG. 7 is a block diagram illustrating an example system for disconnecting power to one or more electrical components and discharging DC link capacitors, in accordance with this disclosure.

FIG. 8 is a flow diagram illustrating an example operation for using power transistor to cause a DC link capacitor to discharge, in accordance with one or more techniques of this disclosure.

### DETAILED DESCRIPTION

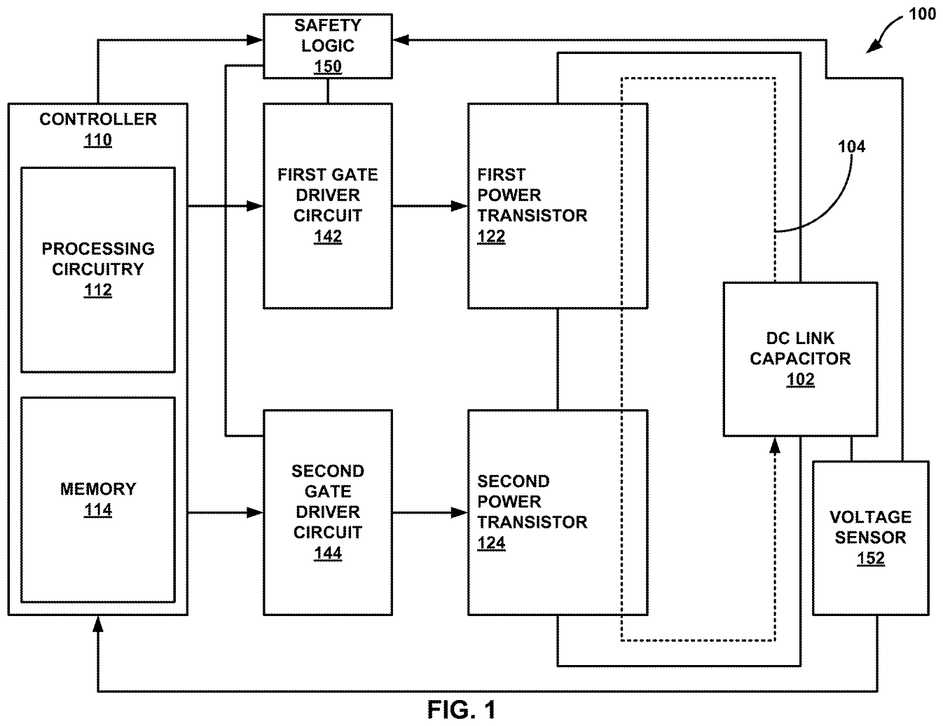

FIG. 1 is a block diagram illustrating a system 100 for discharging a direct current (DC) link capacitor 102, in accordance with this disclosure. For example, system 100 includes DC link capacitor 102, controller 110 including processing circuitry 112 and memory 114, first power transistor 122, second power transistor 124, first gate driver circuit 142, second gate driver circuit 144, safety logic 150, and voltage sensor 152. DC link capacitor 102 may discharge via first power transistor 122 and second power transistor 124 via discharge current pathway 104.

DC link capacitor 102 may represent an electrical circuit component between a power supply and a load. For example, an electric vehicle may include one or more electric motors that draw power from a high-voltage power source such as a battery. DC link capacitor 102 may be important for controlling power delivered from the power source to the load. DC link capacitor 102 may ensure that a voltage spike associated with an electric motor powering up remains below a voltage threshold, and may otherwise regulate power delivered to the load in a way that protects electrical component from damage. For example, when DC link capacitor 102 is charged to a voltage that is similar to a voltage of a high-voltage power source, this may prevent a large voltage imbalance between the high-voltage power source and the load.

A DC link capacitor, in the context of an electric motor drive system, may represent a component used in the power electronics section of the electric motor drive system. Electric motors, especially in variable speed applications, may receive one or more control signals to control speed and torque. Systems may achieve control using power electronic converters, such as inverters or variable frequency drives (VFDs). A DC link capacitor may play an important role in one or more systems for controlling an electric motor by smoothing a voltage supplied to the electric motor to prevent overvoltage spikes. For example, DC link capacitor 102 may play an important role in using an inverter to control an electric motor by smoothing voltage supplied to the electric motor even when one or more switching transients occur.

In many motor drive systems, a rectifier may convert alternating current (AC) power to DC power. A DC link capacitor may be connected across a DC bus and help to smooth out a rectified voltage. The DC link capacitor may act as a buffer, reducing voltage ripples and ensuring a stable DC voltage. A DC link capacitor may store energy during certain phases of operation. For example, during braking or deceleration, when the motor is acting as a generator, excess energy may be fed into the DC bus. The DC link capacitor may observe this energy, preventing voltage spikes and protecting the drive components. The DC link capacitor may maintain a relatively constant DC voltage level, ensuring a stable power supply for an inverter or other power electronics components. The DC link capacitor may act as a filter for high-frequency components in the power system. DC link capacitor 102 may smooth out rapid changes in voltage, contributing to a more efficient and reliable operation of an electric motor drive.

In some cases, it may be beneficial to discharge DC link capacitor 102. Since DC link capacitor 102 is configured to be charged to a high voltage, it may be beneficial to discharge DC link capacitor 102 for safety reasons when one or more failure conditions arise. For example, when system 100 detects a motor vehicle crash, system 100 may automatically discharge DC link capacitor 102 so that the high voltage of DC link capacitor 102 does not harm human occupants of the motor vehicle. System 100 may also discharge DC link capacitor 102 under certain normal operating conditions, such as every time that a motor vehicle is powered down. In any case, system 100 may be configured to discharge DC link capacitor 102 in response to one or more conditions and before a period of time elapses. For example, system 100 may be configured to discharge DC link capacitor 102 in response to detecting a crash event. System 100 may be configured to discharge DC link capacitor 102 in response to detecting a power down event. System 100 may be configured to discharge DC link capacitor 102 in response to detecting a vehicle being turned off.

Controller 110 may be configured to cause DC link capacitor 102 to discharge according to a sequence of discharge phases before a period of time elapses. For example, controller 110 may cause DC link capacitor 102 to discharge via discharge current pathway 104. As seen in FIG. 1, discharge current pathway 104 passes through first power transistor 122 and second power transistor 124. This means that controller 110 may control first power transistor 122 via first gate driver circuit 132 and control second power transistor 124 via second gate driver circuit 144 to cause DC link capacitor 102 to discharge via discharge current pathway 104.

Controller 110 may include processing circuitry 112. Processing circuitry 112 may include, for example, one or more microprocessors, digital signal processors (DSPs), application specific integrated circuits (ASICs), field-programmable gate arrays (FPGAs), or equivalent discrete or integrated logic circuitry, or a combination of any of the foregoing devices or circuitry. Accordingly, processing circuitry 112 may include any suitable structure, whether in hardware, software, firmware, or any combination thereof, to perform the functions ascribed herein to controller 110.

Controller 110 may include a memory 114 in communication with the processing circuitry 112. In some examples, the memory 114 in communication with processing circuitry 112 includes computer-readable instructions that, when executed by the processing circuitry 112, cause controller 110 to perform various functions attributed to controller 110 herein. The memory 114 may include any volatile, non-volatile, magnetic, optical, or electrical media, such as a random-access memory (RAM), read-only memory (ROM), non-volatile RAM (NVRAM), electrically erasable programmable ROM (EEPROM), flash memory, or any other digital media capable of storing information.

In some examples, first power transistor 122 and second power transistor 124 may be collectively referred to as “power transistors 122, 124.” Power transistors 122, 124 may represent semiconductor transistor devices or other kinds of switches configured for power delivery. Each power transistor of power transistors 122, 124 may, in some cases, include a power switch such as, but not limited to, any type of field-effect transistor (FET) including any one or combination of a metal-oxide-semiconductor field-effect transistor (MOSFET), a bipolar junction transistor (BJT), an insulated-gate bipolar transistor (IGBT), a junction field effect transistor (JFET), a high electron mobility transistor (HEMT), or other kinds of elements that use voltage or current for control. Additionally, each power transistor of power transistors 122, 124 may include any one or combination of n-type transistors, p-type transistors, and other kinds of power transistors. In some examples, each power transistor of power transistors 122, 124 includes vertical transistors, lateral transistors, and/or horizontal transistors. In some examples, each power transistor of power transistors 122, 124 includes other analog devices such as diodes and/or thyristors. In some examples, each power transistor of power transistors 122, 124 may operate as a switch and/or operate as an analog device.

In some examples, each power transistor of power transistors 122, 124 includes three terminals: two load terminals and a control terminal. When a power transistor represents a MOSFET, the power transistor may include a drain terminal, a source terminal, and at least one gate terminal, where the control terminal is a gate terminal. When a power transistor represents a BJT switch, the control terminal may represent a base terminal. Current may flow between the two load terminals of a power transistor, based on the voltage at the respective control terminal. Therefore, electrical current may flow across the power transistor based on control signals delivered to the control terminal of the power transistor. In one example, if a voltage applied to the control terminal of the power transistor is greater than or equal to a voltage threshold, the power transistor may be activated, allowing the power transistor to conduct electricity. Furthermore, the power transistor may be deactivated when the voltage applied to the control terminal of the power transistor is below the threshold voltage, thus preventing the power transistor from conducting electricity. Controller 110 may be configured to control each of power transistors 122, 124 by causing first gate driver circuit 142 to deliver a first control signal to a gate terminal of first power transistor 122 and causing second gate driver circuit 144 to deliver a second control signal to a gate terminal of second power transistor 124.

Each power transistor of power transistors 122, 124 may include various material compounds, such as silicon, silicon carbide, gallium nitride, or any other combination of one or more semiconductor materials. In some examples, silicon carbide switches may experience lower switching power losses. Improvements in magnetics and faster switching, such as gallium nitride switches, may allow a power transistor to draw short bursts of current. These higher frequency devices may require control signals (e.g., voltage signals delivered to the control terminal of the power transistor) to be sent with more precise timing, as compared to lower-frequency devices.

As DC link capacitor 102 discharges, electrical current may flow across first power transistor 122 and second power transistor 124 through discharge current pathway 104. In some examples, DC link capacitor 102 may discharge according to a sequence of discharge phases. For example, processing circuitry 112 of controller 110 may control first power transistor 122 to perform a sequence of first switching cycles and processing circuitry 112 may control second power transistor 124 to perform a sequence of second switching cycles. The sequence of first switching cycles and the sequence of second switching cycles may define the sequence of discharge phases. During each discharge phase of the sequence of discharge phases, electrical current may flow from DC link capacitor 102 and a voltage of DC link capacitor 102 may decrease.

In some examples, electrical current may flow from DC link capacitor 102 through discharge current pathway 104 only under certain conditions. One example condition where electrical current flows through discharge current pathway 104 across first power transistor 122 and second power transistor 124 is when both of first power transistor 122 and second power transistor 124 are turned on at the same time. In response to both of first power transistor 122 and second power transistor 124 being turned on at the same time, electrical current may flow through the discharge current pathway 104 that crosses first power transistor 122 and second power transistor 124. In response to one or both of first power transistor 122 and second power transistor 124 being turned off, electrical current might not be able to flow through discharge current pathway 104 because the power transistor that is turned off severs the discharge current pathway 104.

Another example condition where electrical current flows through discharge current pathway 104 across first power transistor 122 and second power transistor 124 is when electrical current from DC link capacitor 102 traverses discharge current pathway 104 at least partially through parasitic capacitances of first power transistor 122 and second power transistor 124. Electrical circuit components other than capacitors may, in some cases, include a parasitic capacitance. That is, an electrical circuit component may include properties that cause the electrical circuit component to behave like a capacitor even if the electrical circuit component is not a capacitor. For example, first power transistor 122 and second power transistor 124 may each include a power transistor such that each of first power transistor 122 and second power transistor 124 is configured to charge and discharge.

First gate driver circuit 142 may be configured to output a first control signal to a gate terminal of first power transistor 122 to control whether first power transistor 122 is turned on or turned off. In some examples, the first control signal may indicate a frequency of first power transistor 122, a duty cycle of first power transistor 122, a gate voltage applied to first power transistor 122, or any combination thereof. First gate driver circuit 142 may, in some examples, generate the first control signal for output to first power transistor 122 based on first information that first gate driver circuit 142 receives from controller 110. That is, controller 110 may control the first control signal that first gate driver circuit 142 outputs to the gate terminal of first power transistor 122. This means that controller 110 is configured to control an operation of first power transistor 122 by outputting the first information to first gate driver circuit 142.

Second gate driver circuit 144 may be configured to output a second control signal to a gate terminal of second power transistor 124 to control whether second power transistor 124 is turned on or turned off. In some examples, the second control signal may indicate a frequency of second power transistor 124, a duty cycle of second power transistor 124, a gate voltage applied to second power transistor 124, or any combination thereof. Second gate driver circuit 144 may, in some examples, generate the second control signal for output to second power transistor 124 based on second information that second gate driver circuit 144 receives from controller 110. That is, controller 110 may control the second control signal that second gate driver circuit 144 outputs to the gate terminal of second power transistor 124. This means that controller 110 is configured to control an operation of second power transistor 124 by outputting the second information to second gate driver circuit 144.

Gate driver circuits 142, 144 may be configured to control power transistors 122, 124 to operate in non-linear mode to discharge DC link capacitor 102. The terms “linear mode” and “non-linear mode” may refer to operating regions of power transistors, including MOSFETs, BJTs, and other kinds of power transistors. Linear mode and non-linear mode may refer to how a power transistor responds to changes in input signals and how the power transistor behaves in amplification and switching. For example, linear mode and non-linear mode may refer to a relationship between a magnitude of a gate voltage applied to a power transistor and one or more parameters of a power signal flowing across the power transistor.

In the linear mode, a power transistor may operate as an amplifier. This means that one or more output parameters of the power transistor are a linear, proportional amplification of one or more input parameters. A power transistor operating in linear mode may be biased in a way that allows the power transistor to respond to small changes in an input parameter such as gate voltage so that one or more output parameters likewise change proportionally to the small changes in the input parameter. Linear mode may be used to amplify analog signals and otherwise process analog signals. In some examples, a power transistor may operate in the linear mode when a gate voltage applied to a gate terminal of the power transistor is within a range from a lower-bound linear mode gate voltage to an upper-bound linear mode gate voltage. A power transistor is not fully turned on when operating in the linear mode. That is, a power transistor does not reach a full potential to conduct electricity when operating in the linear mode. Power transistors operating in linear mode also may exhibit undesirable heating.

In the non-linear mode, a power transistor may operate as a switch. The power transistor operating in the non-linear mode may operate either in a cut-off region where the power transistor is fully turned off or operate a saturation region where the power transistor is fully turned on. One or more output parameters of a power transistor operating in the non-linear mode are not linearly proportional to one or more input parameters of the power transistor. That is, power transistors operating in the non-linear mode may transition between being fully turned off to being fully turned on. This means that non-linear mode may be used when a power transistor operates as a power switch. In some examples, a power transistor may operate in the non-linear mode when a gate voltage applied to a gate terminal of the power transistor is greater than a threshold non-linear mode gate voltage. The threshold non-linear mode gate voltage for a power transistor may be greater than or equal to the upper-bound linear mode gate voltage for the power transistor.

MOSFETs, for example, may operate according to three operational regions including a cut-off operational region, a saturation operational region, and a linear operational region. When a MOSFET operates in the non-linear mode, the MOSFET may alternate between the cut-off operating region where the MOSFET is fully turned off and the saturation region where the MOSFET is fully turned on. In the cut-off operating region, no electrical current or a minimal amount of electrical current may flow across the MOSFET. In the saturation region, the MOSFET is fully turned on and electrical current flows freely across the MOSFET. The MOSFET operates in the linear mode when operating in the linear operational region, where the MOSFET acts as an amplifier.

Controller 110 may be configured to control first power transistor 122 to perform a sequence of first switching cycles. To control first power transistor 122 to perform the sequence of first switching cycles, controller 110 may cause first gate driver circuit 142 to apply, for each switching cycle of the sequence of first switching cycles, a first gate voltage to a first gate terminal of first power transistor 122. The first gate voltage that first gate driver circuit 142 applies to the gate terminal of first power transistor 122 may exceed a threshold non-linear mode gate voltage so that the first power transistor 122 operates in the non-linear mode. That is, first power transistor 122 may operate according to a non-linear transfer function. To perform the sequence of first switching cycles, first power transistor 122 may alternate between being fully turned on and being fully turned off.

Controller 110 may be configured to control second power transistor 124 to perform a sequence of second switching cycles. To control second power transistor 12r to perform the sequence of second switching cycles, controller 110 may cause second gate driver circuit 144 to apply, for each switching cycle of the sequence of second switching cycles, a second gate voltage to a second gate terminal of second power transistor 124. The second gate voltage that second gate driver circuit 144 applies to the gate terminal of second power transistor 124 may exceed a threshold non-linear mode gate voltage so that the second power transistor 124 operates in the non-linear mode. That is, second power transistor 124 may operate according to a non-linear transfer function. To perform the sequence of second switching cycles, second power transistor 124 may alternate between being fully turned on and being fully turned off.

By controlling the first power transistor 122 to perform the sequence of first switching cycles and controlling the second power transistor 124 to perform the sequence of second switching cycles, controller 110 causes DC link capacitor 102 to discharge according to a sequence of discharge phases via the discharge current pathway 104. In response to the first power transistor 122 performing the sequence of first switching cycles and the second power transistor 124 performing the sequence of second switching cycles, first power transistor 122 and second power transistor 124 may control the sequence of discharge phases. That is, one or more parameters of the sequence of discharge phases may depend on the sequence of first switching cycles and the sequence of second switching cycles.

When first power transistor 122 operates in non-linear mode and performs the sequence of first switching cycles, first power transistor 122 may alternate between activation phases during which the first power transistor 122 operates in the saturation region where first power transistor 122 is fully turned on and deactivation phases during which first power transistor 122 operates in the cut-off region where first power transistor 122 is fully turned off. Each switching cycle of the sequence of first switching cycles may comprise an activation phase and a deactivation phase. When second power transistor 124 operates in non-linear mode and performs the sequence of second switching cycles, second power transistor 124 may alternate between activation phases during which the second power transistor 124 operates in the saturation region where second power transistor 124 is fully turned on and deactivation phases during which second power transistor 124 operates in the cut-off region where second power transistor 124 is fully turned off. Each switching cycle of the sequence of second switching cycles may comprise an activation phase and a deactivation phase.

In some examples, the sequence of discharge phases during which DC link capacitor 102 discharges via discharge current pathway 104 may correspond to one or more periods of overlap between activation phases of the sequence of first switching cycles and activation phases of the sequence of second switching cycles. That is, when there is a period of overlap between an activation phase of the sequence of first switching cycles and an activation phase of the sequence of second switching cycles, both of the first power transistor 122 and the second power transistor 124 are fully turned on during the period of overlap such that electrical current flows from DC link capacitor 102 across first power transistor 122 and second power transistor 124 during the period of overlap. This means that controller 110 may control the sequence of first switching cycles and the sequence of second switching cycles to define the sequence of discharge phases, each discharge phase corresponding to a period of overlap between an activation phase of the sequence of first switching cycles and an activation phase of the sequence of second switching cycles.

In some examples, the sequence of discharge phases during which DC link capacitor 102 discharges via discharge current pathway 104 may exist even when there are no periods of overlap between activation phases of the sequence of first switching cycles and activation phases of the sequence of second switching cycles. For example, electrical current may traverse discharge current pathway 104 even when there are no periods of time during which first power transistor 122 and second power transistor 124 are both fully turned off. This may occur via parasitic capacitances of first power transistor 122 and second power transistor 124. For example, electrical current from DC link capacitor 102 may charge a parasitic capacitance of first power transistor 122 The parasitic capacitance of first power transistor 122 may discharge to charge a parasitic capacitance of second power transistor 124. The parasitic capacitance of second power transistor 124 may discharge to complete discharge current pathway 104.

DC link capacitor 102 may, in some examples discharge both during periods of overlap between activation phases of the sequence of first switching cycles and activation phases of the sequence of second switching cycles and according to charge and discharge of parasitic capacitances of power transistors 122, 124. That is, electrical current may flow freely across both first power transistor 122 and second power transistor 124 during periods of time where both of first power transistor 122 and second power transistor 124. Additionally, electrical current from DC link capacitor 102 may charge a parasitic capacitance of first power transistor 122, the parasitic capacitance of first power transistor 122 may discharge to charge the parasitic capacitance of second power transistor 124, and the parasitic capacitance of second power transistor 124 may discharge to complete discharge current pathway 104.

In some examples, system 100 may include safety logic 150 separate from controller 110. In some examples, safety logic 150 may be configured to control first gate driver circuit 142 to deliver the first control signal to first power transistor 122 and control second gate driver circuit 144 to deliver the second control signal to second power transistor 124. Safety logic 150 may, in some examples, perform any function described herein as being performed by controller 110. In some examples, safety logic 150 may control first power transistor 122 and second power transistor 124 to discharge DC link capacitor 102 in response to one or more safety conditions arising. For example, in response to safety logic 150 determining that DC link capacitor 102 must be discharged, safety logic 150 may initiate a discharge of DC link capacitor 102. Although safety logic 150 is illustrated in FIG. 1 as being separate from first gate driver circuit 142 and second gate driver circuit 144, safety logic 150 may in some cases be part of first gate driver circuit 142 and second power transistor 144.

In some examples, controller 110 controls first gate driver circuit 142 and second gate driver circuit 144 in response to system 100 operating according to a normal operation mode and safety logic 150 controls first gate driver circuit 142 and second gate driver circuit 144 in response to system 100 operating according to a safety operation mode. In some examples, controller 110 may output a message to safety logic 150 in response to system 100 transitioning from the normal operation mode to the safety operation mode. In response to safety logic 150 receiving the message, safety logic 150 may control first gate driver circuit 142 and second gate driver circuit 144.

To cause DC link capacitor 102 to discharge according to a sequence of discharge phases, controller 110 is configured to cause, for each discharge phase of the sequence of discharge phases, electrical current to flow from DC link capacitor 102 via the discharge current pathway 104. For example, during each discharge phase of the sequence of discharge phases, electrical current may flow from DC link capacitor 102, thus causing a voltage of the DC link capacitor 102 to decrease. Throughout the sequence of discharge phases, DC link capacitor 102 may discharge from a high voltage to a low voltage. In some examples, DC link capacitor 102 may discharge before a period of time elapses. In some examples, the period of time is within a range from 0.5 seconds to 3 seconds (e.g., 1 second). That is, DC link capacitor 102 may discharge according to a sequence of discharge phases within a period of time within the range from 0.5 seconds to 3 seconds.

In some examples, to cause DC link capacitor 102 to discharge according to a sequence of discharge phases, controller 110 is configured to cause a voltage of the DC link capacitor 102 to discharge from a first voltage value to a second voltage value. In some examples, each discharge phase of the sequence of discharge phases may decrease the voltage of the DC link capacitor 102 until the voltage of the DC link capacitor 102 is less than or equal to the second voltage value. In some examples, the first voltage may represent a high voltage value that is similar to a voltage of a high-voltage power source for supplying power to one or more electric motors of an electric vehicle. For example, the first voltage may be within a range from 400 Volts (V) to 900V. In some examples, the second voltage value represents a voltage that does not pose a safety hazard or poses a significantly decreased safety hazard. The second voltage value may be within a range from 0V to 60V.

In some examples, voltage sensor 152 may be configured to generate a voltage signal that indicates a voltage of DC link capacitor 102. Controller 110 may, in some examples, receive the voltage signal from voltage sensor 152. Controller 110 may initiate a discharge of DC link capacitor 102 from a first voltage to a second voltage lower than the first voltage. Controller 110 may determine, based on the voltage signal received from voltage sensor 152, that the voltage of DC link capacitor 102 is less than or equal to the second voltage value. In response to determining that the voltage of DC link capacitor 102 is less than or equal to the second voltage value, controller 110 may control the first power transistor 122 to cease the sequence of first switching cycles. In response to determining that the voltage of DC link capacitor 102 is less than or equal to the second voltage value, controller 110 may control the second power transistor 124 to cease the sequence of second switching cycles.

In some examples, system 100 may transition from a normal operation mode to a safety operation mode. In the safety operation mode, safety logic 150 may take over controlling first gate driver circuit 142 and second gate driver circuit 144 from controller 110. For example, controller 110 may cause system 100 to transition to the safety mode by outputting a message to safety logic 150. When system 100 operates according to the safety operation mode, safety logic 150 may receive a voltage signal from voltage sensor 152. Safety logic 150 may initiate a discharge of DC link capacitor 102 from a first voltage to a second voltage lower than the first voltage. Safety logic 150 may determine, based on the voltage signal received from voltage sensor 152, that the voltage of DC link capacitor 102 is less than or equal to the second voltage value. In response to determining that the voltage of DC link capacitor 102 is less than or equal to the second voltage value, safety logic 150 may control the first power transistor 122 to cease the sequence of first switching cycles. In response to determining that the voltage of DC link capacitor 102 is less than or equal to the second voltage value, safety logic 150 may control the second power transistor 124 to cease the sequence of second switching cycles.

Controller 110 may be configured to cause a discharge of DC link capacitor 102 to cease automatically and without input from voltage sensor 152. For example, controller 110 may initiate a discharge of DC link capacitor 102 by causing first power transistor 122 to begin a sequence of first switching cycles and causing second power transistor 124 to begin a sequence of second switching cycles. Controller 110 may control the first power transistor 122 to cease the sequence of first switching cycles when a period of time elapses following a start of the sequence of first switching cycles. Controller 110 may control the second power transistor 124 to cease the sequence of second switching cycles when a period of time elapses following a start of the sequence of second switching cycles.

Controller 110 may determine whether to initiate a discharge of DC link capacitor 102 and control first power transistor 122 and second power transistor 124 to discharge DC link capacitor 102 in response to determining to initiate the discharge. For example, controller 110 may identify one or more failure conditions prompting a discharge operation to cause DC link capacitor 102 to discharge. The one or more failure conditions may include a motor vehicle accident, a hardware failure, a failure of one or more other electrical components, or any combination thereof. Controller 110 may initiate the discharge operation. The discharge operation includes the first power transistor 122 performing the sequence of first switching cycles and the second power transistor 124 performing the sequence of second switching cycles. Controller 110 is not limited to discharging DC link capacitor 102 based on detecting failure conditions. In some examples, controller 110 may identify one or more standard operating modes prompting a discharge operation to cause DC link capacitor 102 to discharge and initiate the discharge operation based on identifying the one or more normal operating modes. Normal operating modes prompting discharge of DC link capacitor 102 may include powering down an electric vehicle or one or more other normal operating modes.

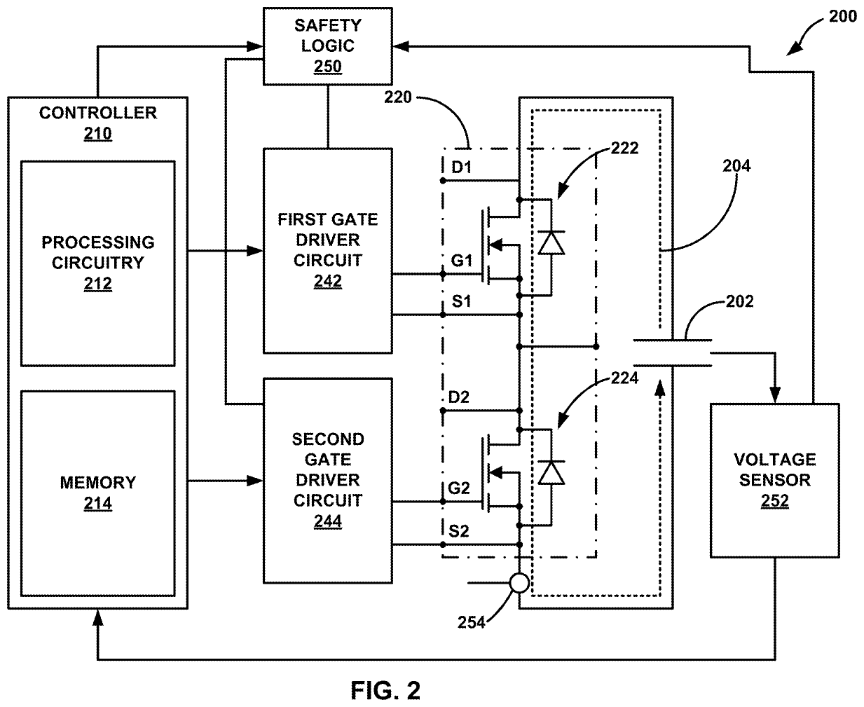

FIG. 2 is a circuit diagram illustrating a system 200 for discharging a DC link capacitor 202 through a discharge current pathway 204 across a first power transistor 222 and a second power transistor 224, in accordance with this disclosure. For example, system 200 includes DC link capacitor 202, controller 210 including processing circuitry 212 and memory 214, power module 220 including first power transistor 222 and second power transistor 224, first gate driver circuit 242, second gate driver circuit 244, safety logic 250, voltage sensor 252, and current sensor 254. DC link capacitor 202 may discharge via first power transistor 222 and second power transistor 224 via discharge current pathway 204.

System 200 may be an example of system 100 of FIG. 1. DC link capacitor 202 may be an example of DC link capacitor 102 of FIG. 1. Controller 210 may be an example of controller 110 of FIG. 1. Processing circuitry 212 may be an example of processing circuitry 112 of FIG. 1. Memory 214 may be an example of memory 114 of FIG. 1. First power transistor 222 is an example of first power transistor 122 of FIG. 1. Second power transistor 224 is an example of second power transistor 124 of FIG. 1. First gate driver circuit 242 may be an example of first gate driver circuit 142 of FIG. 1. Second gate driver circuit 244 may be an example of second gate driver circuit 144 of FIG. 1. Safety logic 250 may be an example of safety logic 150 of FIG. 1. Voltage sensor 252 maybe an example of voltage sensor 152 of FIG. 1.

System 200 may be substantially the same as system 100 of FIG. 1, except that system 200 includes a power module 220 illustrating additional detail concerning first power transistor 222 and second power transistor 224. For example, power module 220 includes a first source terminal (S1) of first power transistor 222, a first drain terminal (D1) of first power transistor 222, and a first gate terminal (G1) of first power transistor 222. Power module 220 also includes a second source terminal (S2) of second power transistor 224, a second drain terminal (D2) of second power transistor 224, and a second gate terminal (G2) of second power transistor 224. System 200 also includes a current sensor 254 that is not illustrated as being part of system 100 of FIG. 1.

Controller 210 may cause DC link capacitor 202 to discharge via discharge current pathway 204. As seen in FIG. 2, first gate driver circuit 242 is connected to the first gate terminal G1 of first power transistor 222. First gate driver circuit 242 is also connected to the first source terminal S1 of first power transistor 222. In some examples, first gate driver circuit 242 may deliver a first control signal to first gate terminal G1 of first power transistor 222. First gate driver circuit 242 may be configured to sense one or more parameters of the first source terminal S1 of first power transistor 222. For example, first gate driver circuit 242 may sense a voltage at first source terminal S1 and/or a current at first source terminal S1. By delivering the first control signal to first gate terminal G1 of first power transistor 222, first gate driver circuit 242 may cause first power transistor 222 to perform a sequence of first switching cycles.

Second gate driver circuit 244 is connected to the second gate terminal G2 of second power transistor 224. Second gate driver circuit 244 is also connected to the second source terminal S2 of second power transistor 224. In some examples, second gate driver circuit 244 may deliver a second control signal to second gate terminal G2 of second power transistor 224. Second gate driver circuit 244 may be configured to sense one or more parameters of the second source terminal S2 of second power transistor 224. For example, second gate driver circuit 244 may sense a voltage at second source terminal S2 and/or a current at second source terminal S2. By delivering the second control signal to second gate terminal G2 of second power transistor 224, second gate driver circuit 244 may cause second power transistor 224 to perform a sequence of second switching cycles.

In some examples, controller 210 may be configured to output first information to first gate driver circuit 242 to cause first gate driver circuit 242 to output the first control signal to first gate terminal G1 of first power transistor 222. Controller 210 may be configured to output second information to second gate driver circuit 244 to cause second gate driver circuit 244 to output the second control signal to second gate terminal G2 of second power transistor 224. Controller 210 is not the only component configured to control first gate driver circuit 242 and second gate driver circuit 244. Safety logic 250 may be configured to cause first gate driver circuit 242 to output the first control signal to first gate terminal G1 of first power transistor 222. Safety logic 250 may be configured to cause second gate driver circuit 244 to output the second control signal to second gate terminal G2 of second power transistor 224.

In some examples, DC link capacitor 202 may discharge from a first voltage to a second voltage. The first voltage may be a high voltage, such as greater than 400V. The second voltage may be a low voltage, such as 60V. Voltage sensor 252 may be configured to sense a voltage of DC link capacitor 202 and output a voltage signal to controller 210 indicating the voltage of DC link capacitor 202. Controller 210 may cause the DC link capacitor 202 to discharge based on the voltage signal. For example, controller 210 may cause the DC link capacitor 202 to begin discharging from the first voltage. controller 210 may cause the DC link capacitor 202 to cease discharging based on determining that the voltage of DC link capacitor 202 is less than or equal to the second voltage. In some examples, controller 210 may cause the DC link capacitor 202 to discharge without determining the voltage of DC link capacitor 202. For example, controller 210 may cause the DC link capacitor 202 to begin discharging and subsequently cease discharging when a period of time elapses following the start of discharging. Current sensor 254 may be configured to sense a current along discharge current pathway 204.

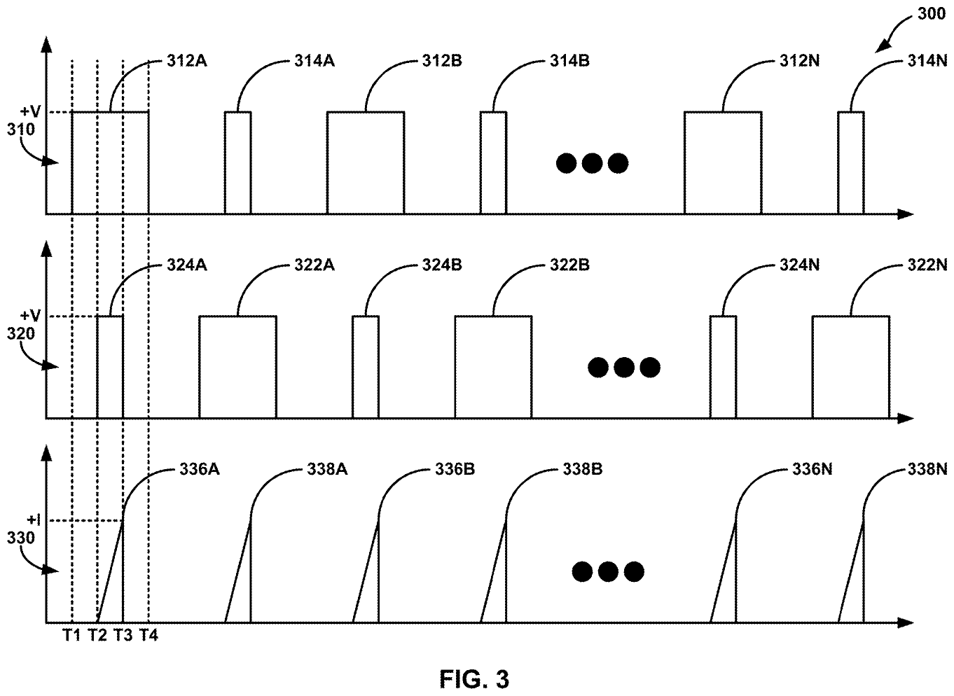

FIG. 3 is a plot diagram illustrating a first timeseries plot 300 of a sequence of first switching cycles 310, a sequence of second switching cycles 320, and a sequence of discharge phases 330, in accordance with this disclosure. As seen in FIG. 3, the sequence of first switching cycles 310 includes a set of long activation phases 312A-312N (collectively, “long activation phases 312”) and a set of short activation phases 314A-314N (collectively, “short activation phases 314”). The sequence of second switching cycles 320 includes a set of long activation phases 322A-322N (collectively, “long activation phases 322”) and a set of short activation phases 324A-324N (collectively, “short activation phases 324”). The sequence of discharge phases 330 may include discharge phases 336A-336N (collectively, “discharge phases 336”) and discharge phases 338A-338N (collectively, “discharge phases 338”).

In some examples, first power transistor 122 of FIG. 1 is configured to perform the sequence of first switching cycles 310. Second power transistor 124 of FIG. 1 may be configured to perform the sequence of second switching cycles 320. In the sequence of first switching cycles 310, first power transistor 122 may be turned on and operating in the saturation region during long activation phases 312 and short activation phases 314. A duration of each short activation phase of short activation phases 314 may be shorter than a duration of each long activation phase of long activation phases 312. First power transistor 122 may be turned off and operating in the cut-off region during periods of time between activation phases (e.g., between long activation phase 312A and short activation phase 314A). In the sequence of second switching cycles 320, second power transistor 124 may be turned on and operating in the saturation region during long activation phases 322 and short activation phases 324. A duration of each short activation phase of short activation phases 324 may be shorter than a duration of each long activation phase of long activation phases 322. Second power transistor 124 may be turned off and operating in the cut-off region during periods of time between activation phases (e.g., between short activation phase 324A and long activation phase 322A).

Since first power transistor 122 and second power transistor 124 both toggle between the saturation region during activation phases and the cut-off region during deactivation phases, first power transistor 122 and second power transistor 124 may both operate in the non-linear mode. This means that first power transistor 122 and second power transistor 124 may perform the sequence of first switching cycles 310 and the sequence of second switching cycles 320, respectively, by alternating between being fully turned on and being fully turned off. This means that first power transistor 122 and second power transistor 124 may alternating between being fully turned on and being fully turned off without acting as amplifiers. In some examples, a gate voltage applied to the gate terminal of first power transistor 122 during long activation phases 312 and short activation phases 314 (+V) exceeds a threshold gate voltage so that the first power transistor 122 operates in the non-linear mode. In some examples, a gate voltage applied to the gate terminal of second power transistor 124 during long activation phases 322 and short activation phases 324 (+V) exceeds the threshold gate voltage so that the second power transistor 124 operates in the non-linear mode.

As seen in FIG. 3, long activation phase 312A of the sequence of first switching cycles 310 extends from time T1 to time T4. Short activation phase 324A of the sequence of second switching cycles 320 extends from time T2 to time T3. This means that between time T2 and time T3, both of first power transistor 122 and second power transistor 124 are fully turned on and operating in the saturation region. This means that electrical current may flow from DC link capacitor 102 across first power transistor 122 and second power transistor 124 between time T2 and time T3 when both of first power transistor 122 and second power transistor 124 are fully turned on. For example, discharge phase 336A of discharge phases 336 may occur between time T2 and time T3 when both of first power transistor 122 and second power transistor 124 are fully turned on. The magnitude of the electrical current flowing across first power transistor 122 and second power transistor 124 may increase to a maximum current (+I) over the period of time between time T2 and time T3.

Each saturation phase of discharge phases 336 may correspond to a period of overlap between a long activation phase of long activation phases 312 performed by first power transistor 122 and a short activation phase of short activation phases 324 performed by second power transistor 124. Each saturation phase of saturation phases 338 may correspond to a period of overlap between a short activation phase of short activation phases 314 performed by first power transistor 122 and a long activation phase of long activation phases 322 performed by second power transistor 124. During each saturation phase of discharge phases 336, 338, electrical current may flow from DC link capacitor 102 through first power transistor 122 and second power transistor 124, decreasing a voltage of DC link capacitor 102 by an amount of voltage. Throughout discharge phases 336, 338, the voltage of DC link capacitor 102 may decrease from a first voltage to a second voltage lower than the first voltage.

In some examples, long activation phases 312 and short activation phases 314 performed by first power transistor 122 may be interleaved so that a short activation phase of short activation phases 314 occurs between each pair of consecutive long activation phases of long activation phases 312. Long activation phases 322 and short activation phases 324 performed by second power transistor 124 may be interleaved so that a short activation phase of short activation phases 324 occurs between each pair of consecutive long activation phases of long activation phases 322. Long activation phases 312 may be aligned in time with short activation phases 324 and short activation phases 314 may be aligned in time with long activation phases 322.

By interleaving long activation phases and short activation phases performed by each of first power transistor 122 and second power transistor 124 so that short activation phases performed by first power transistor 122 align with long activation phases performed by second power transistor 124 and vice versa, controller 110 may distribute stress evenly between first power transistor 122 and second power transistor 124. For example, during discharge phases 336 a greater amount of stress may be applied to second power transistor 124 as compared with stress applied to first power transistor 122. During saturation phases 338 a greater amount of stress may be applied to first power transistor 122 as compared with stress applied to second power transistor 124. This means that stress may be distributed evenly between first power transistor 122 and second power transistor 124.

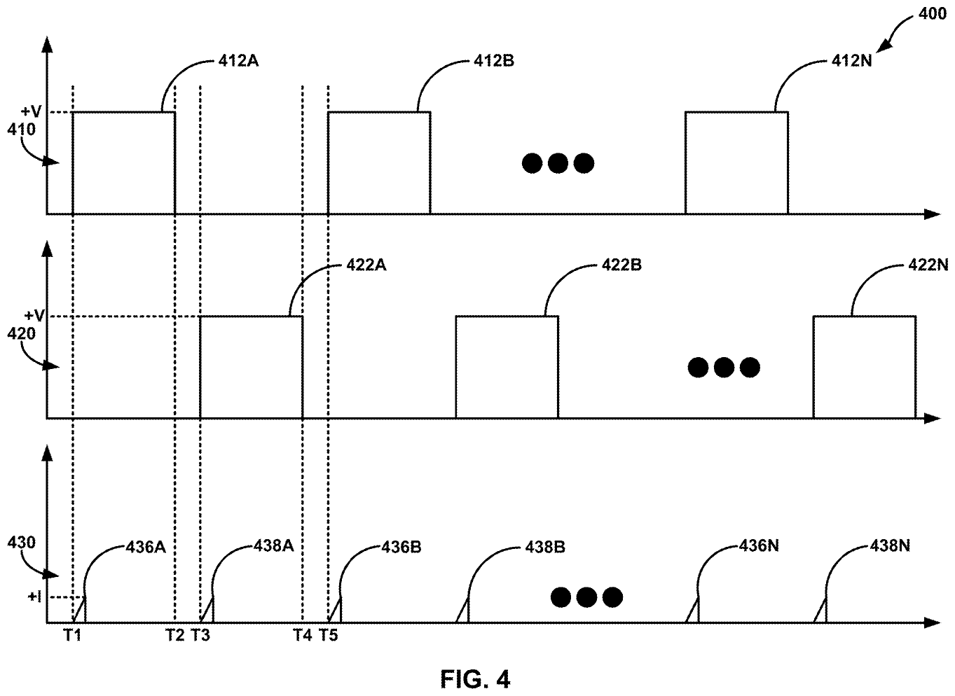

FIG. 4 is a plot diagram illustrating a second timeseries plot 400 of a sequence of first switching cycles 410, a sequence of second switching cycles 420, and a sequence of discharge phases 430, in accordance with this disclosure. As seen in FIG. 4, the sequence of first switching cycles 410 includes a set of activation phases 412A-412N (collectively, “activation phases 412”). The sequence of second switching cycles 420 includes a set of activation phases 422A-422N (collectively, “activation phases 422”). The sequence of discharge phases 430 may include discharge phases 436A-436N (collectively, “discharge phases 436”) and discharge phases 438A-438N (collectively, “discharge phases 438”).

In some examples, first power transistor 122 of FIG. 1 is configured to perform the sequence of first switching cycles 410. Second power transistor 124 of FIG. 1 may be configured to perform the sequence of second switching cycles 420. In the sequence of first switching cycles 410, first power transistor 122 may be turned on and operating in the saturation region during activation phases 412. In some examples, a duration of each activation phase of activation phases 412 may be substantially the same as a duration of each other activation phase of activation phases 412. First power transistor 122 may be turned off and operating in the cut-off region during periods of time between activation phases (e.g., between activation phase 412A and activation phase 412B). In the sequence of second switching cycles 420, second power transistor 124 may be turned on and operating in the saturation region during activation phases 422. In some examples, a duration of each activation phase of activation phases 422 may be substantially the same as a duration of each other activation phase of activation phases 422. Second power transistor 124 may be turned off and operating in the cut-off region during periods of time between activation phases (e.g., between activation phase 424A and activation phase 424B).

First power transistor 122 and second power transistor 124 may operate in the non-linear mode when performing the sequence of first switching cycles 410 and the sequence of second switching cycles 420, respectively. That is, first power transistor 122 may perform the sequence of first switching cycles 410 and second power transistor 124 may perform the sequence of second switching cycles 420 by alternating between being fully turned on and being fully turned off. In some examples, a gate voltage applied to the gate terminal of first power transistor 122 during activation phases 412 (+V) exceeds a threshold gate voltage so that the first power transistor 122 operates in the non-linear mode. In some examples, a gate voltage applied to the gate terminal of second power transistor 124 during activation phases 422 and (+V) exceeds the threshold gate voltage so that the second power transistor 124 operates in the non-linear mode.

As seen in FIG. 4, activation phase 412A of the sequence of first switching cycles 410 extends from time T1 to time T2. Activation phase 422A of the sequence of second switching cycles 420 extends from time T3 to time T4. There is a period of time between time T2 and time T3 during which both of first power transistor 122 and second power transistor 124 are deactivated and operating in the cut-off region. In the example of second timeseries plot 400, there is no period of time during which both of first power transistor 122 and second power transistor 124 are activated and operating in the saturation region. This means that there is no period of time where first power transistor 122 and second power transistor 124 are both activated to complete discharge current pathway 104 through first power transistor 122 and second power transistor 124.

Even though in the example of second timeseries plot 400 there are no periods of overlap between activation phases 412 of the sequence of first switching cycles 410 and activation phases 422 of the sequence of second switching cycles 420, DC link capacitor 102 may still discharge through discharge current pathway 104 via parasitic capacitances of first power transistor 122 and second power transistor 124. For example, a parasitic capacitance of first power transistor 122 may charge even when one or both of first power transistor 122 and second power transistor 124 is deactivated. The parasitic capacitance of first power transistor 122 may discharge to charge a parasitic capacitance of second power transistor 124 even when one or both of first power transistor 122 and second power transistor 124 is deactivated. The parasitic capacitance of second power transistor 124 may discharge to complete discharge current pathway 104 even when one or both of first power transistor 122 and second power transistor 124 is deactivated.

Since electrical current output from DC link capacitor 102 is configured to traverse discharge current pathway 104 via parasitic capacitances of first power transistor 122 and second power transistor 124 even when there is no period of overlap between activation phases of the sequence of first switching cycles 410 and activation phases of the sequence of second switching cycles 420, first power transistor 122 may perform the sequence of first switching cycles 410 and second power transistor 124 may perform the sequence of second switching cycles 420 to discharge DC link capacitor 102 from a first voltage to a second voltage. For example, DC link capacitor 102 may discharge throughout discharge phases 436 and discharge phases 438.

As seen in FIG. 4, each discharge phase of discharge phases 436 may begin at a start of an activation phase of activation phases 412 and each discharge phase of discharge phases 438 begins at a start of an activation phase of activation phases 422. In response to first power transistor 122 activating at a start of each activation phase of activation phases 412, this may cause one or both of the parasitic capacitance of first power transistor 122 and the parasitic capacitance of second power transistor 124 to discharge through discharge current pathway 104. In response to second power transistor 124 activating at a start of each activation phase of activation phases 422, this may cause one or both of the parasitic capacitance of first power transistor 122 and the parasitic capacitance of second power transistor 124 to discharge through discharge current pathway 104.

An electrical current through discharge current pathway 104 may increase to a maximum current (+I) over a period of time following a start of each activation phase of activation phases 412. For example, the electrical current through discharge current pathway 104 increases to the maximum current over the discharge phase 436A following the start of activation phase 412A at time T1, the electrical current through discharge current pathway 104 increases to the maximum current over the discharge phase 436B following the start of activation phase 412B at time T5, and so on. Furthermore, an electrical current through discharge current pathway 104 may increase to the maximum current over a period of time following a start of each activation phase of activation phases 422. For example, the electrical current through discharge current pathway 104 increases to the maximum current over the discharge phase 438A following the start of activation phase 422A at time T3, the electrical current through discharge current pathway 104 increases to the maximum current over the discharge phase 438B following the start of activation phase 422B, and so on.

In response to first power transistor 122 performing the sequence of first switching cycles 410 and the second power transistor 124 performing the sequence of second switching cycles 420, DC link capacitor 102 may discharge through the discharge current pathway 104 from a first voltage to a second voltage even though there are no regions of overlap between activation phases 412 and activation phases 422. Electrical current discharged by DC link capacitor 102 may traverse the discharge current pathway 104 via parasitic capacitances of first power transistor 122 and second power transistor. Since activation phases 412 and activation phases 422 are interleaved, this may distribute stress equally between first power transistor 122 and second power transistor 124.

In some examples, the maximum current associated with discharge phases 436, 438 in the example of second timeseries plot 400 where there are no regions of overlap between activation phases of power transistors 122, 124 is lower than the maximum current associated with discharge phases 336, 338 in the example of first timeseries plot 300 of FIG. 3 where there are regions of overlap between activation phases of power transistors 122, 124. This is because electrical current is able to flow more freely through discharge current pathway 104 when both of first power transistor 122 and second power transistor 124 are activated at the same time as compared with examples where one or both of first power transistor 122 and second power transistor 124 is deactivated. That is, in the example of second timeseries plot 400 where electrical current relies on parasitic capacitances of first power transistor 122 and second power transistor 124 to traverse discharge current pathway 104, the magnitude of the electrical current is limited by the capacity of parasitic capacitances of first power transistor 122 and second power transistor 124.

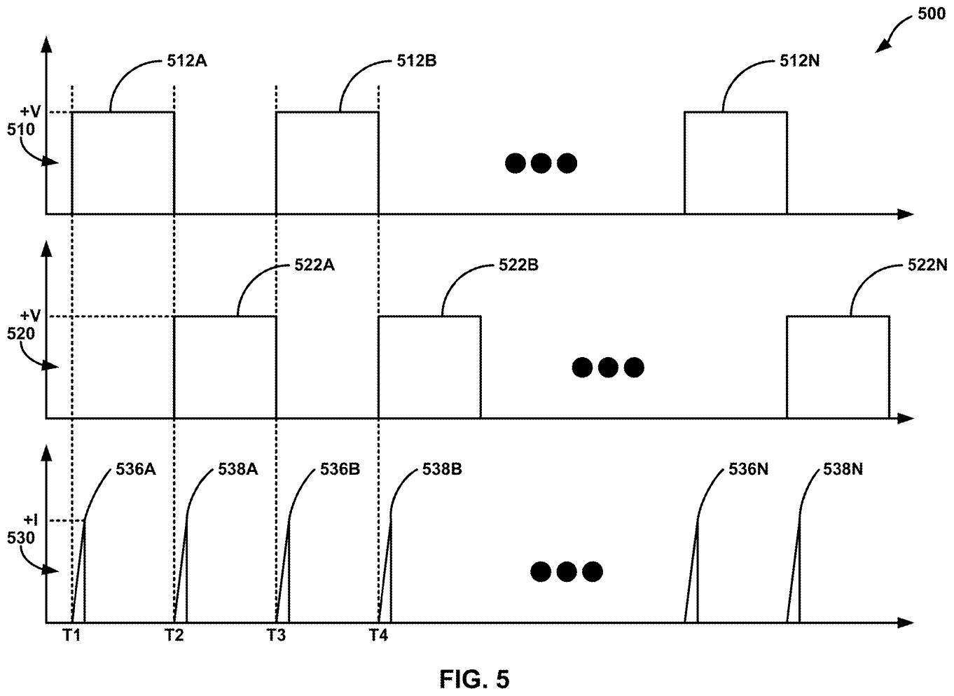

FIG. 5 is a plot diagram illustrating a third timeseries plot 500 of a sequence of first switching cycles 510, a sequence of second switching cycles 520, and a sequence of discharge phases 530, in accordance with this disclosure. As seen in FIG. 5, the sequence of first switching cycles 510 includes a set of activation phases 512A-512N (collectively, “activation phases 512”). The sequence of second switching cycles 520 includes a set of activation phases 522A-522N (collectively, “activation phases 522”). The sequence of discharge phases 530 may include discharge phases 536A-536N (collectively, “discharge phases 536”) and discharge phases 538A-538N (collectively, “discharge phases 538”).

In some examples, first power transistor 122 of FIG. 1 is configured to perform the sequence of first switching cycles 510. Second power transistor 124 of FIG. 1 may be configured to perform the sequence of second switching cycles 520. In the sequence of first switching cycles 510, first power transistor 122 may be turned on and operating in the saturation region during activation phases 512. In some examples, a duration of each activation phase of activation phases 512 may be substantially the same as a duration of each other activation phase of activation phases 512. First power transistor 122 may be turned off and operating in the cut-off region during periods of time between activation phases (e.g., between activation phase 512A and activation phase 512B). In the sequence of second switching cycles 520, second power transistor 124 may be turned on and operating in the saturation region during activation phases 522. In some examples, a duration of each activation phase of activation phases 522 may be substantially the same as a duration of each other activation phase of activation phases 522. Second power transistor 124 may be turned off and operating in the cut-off region during periods of time between activation phases (e.g., between activation phase 524A and activation phase 524B).

First power transistor 122 and second power transistor 124 may operate in the non-linear mode when performing the sequence of first switching cycles 510 and the sequence of second switching cycles 520, respectively. That is, first power transistor 122 may perform the sequence of first switching cycles 510 and second power transistor 124 may perform the sequence of second switching cycles 520 by alternating between being fully turned on and being fully turned off. In some examples, a gate voltage applied to the gate terminal of first power transistor 122 during activation phases 512 (+V) exceeds a threshold gate voltage so that the first power transistor 122 operates in the non-linear mode. In some examples, a gate voltage applied to the gate terminal of second power transistor 124 during activation phases 522 and (+V) exceeds the threshold gate voltage so that the second power transistor 124 operates in the non-linear mode.

As seen in FIG. 5, activation phase 512A of the sequence of first switching cycles 510 extends from time T1 to time T2. Activation phase 522A of the sequence of second switching cycles 520 extends from time T2 to time T3. There That is, activation phase 512A ends at the same time T2 at which activation phase 522A begins. There may, in some cases, be a very brief instant at time T2 when both of first power transistor 122 and second power transistor 124 are activated. In some cases, at time T2, first power transistor 122 is in a process of turning off and second power transistor 124 is in a process of turning on. This means that at time T2, there may be a very brief period of time where first power transistor 122 and second power transistor 124 are both at least partially activated to complete discharge current pathway 104 through first power transistor 122 and second power transistor 124.

Even though in the example of third timeseries plot 500 there are very brief periods of overlap between activation phases 512 of the sequence of first switching cycles 510 and activation phases 522 of the sequence of second switching cycles 520, DC link capacitor 102 may still discharge through discharge current pathway 104 via parasitic capacitances of first power transistor 122 and second power transistor 124. For example, a parasitic capacitance of first power transistor 122 may charge even when one or both of first power transistor 122 and second power transistor 124 is deactivated. The parasitic capacitance of first power transistor 122 may discharge to charge a parasitic capacitance of second power transistor 124 even when one or both of first power transistor 122 and second power transistor 124 is deactivated. The parasitic capacitance of second power transistor 124 may discharge to complete discharge current pathway 104 even when one or both of first power transistor 122 and second power transistor 124 is deactivated.

Since electrical current output from DC link capacitor 102 is configured to traverse discharge current pathway 104 via parasitic capacitances of first power transistor 122 and second power transistor 124 even when there are only very brief periods of overlap between activation phases of the sequence of first switching cycles 510 and activation phases of the sequence of second switching cycles 520, first power transistor 122 may perform the sequence of first switching cycles 510 and second power transistor 124 may perform the sequence of second switching cycles 520 to discharge DC link capacitor 102 from a first voltage to a second voltage. In the example of third timeseries plot 500, DC link capacitor 102 may discharge through electrical current travelling through discharge current pathway 104 when both of first power transistor 122 and second power transistor 124 are activated for very brief periods of time (e.g., at time T1, at time T2, at time T3, and at time T4), and through electrical current travelling through discharge current pathway 104 via parasitic capacitances of first power transistor 122 and second power transistor 124. DC link capacitor 102 may discharge throughout discharge phases 536 and discharge phases 538.

An electrical current through discharge current pathway 104 may increase to a maximum current (+I) over a period of time following a start of each activation phase of activation phases 512. For example, the electrical current through discharge current pathway 104 increases to the maximum current over the discharge phase 536A following the start of activation phase 512A at time T1, the electrical current through discharge current pathway 104 increases to the maximum current over the discharge phase 536B following the start of activation phase 512B at time T3, and so on. Furthermore, an electrical current through discharge current pathway 104 may increase to the maximum current over a period of time following a start of each activation phase of activation phases 522. For example, the electrical current through discharge current pathway 104 increases to the maximum current over the discharge phase 538A following the start of activation phase 522A at time T2, the electrical current through discharge current pathway 104 increases to the maximum current over the discharge phase 538B following the start of activation phase 522B at time T4, and so on.

In response to first power transistor 122 performing the sequence of first switching cycles 510 and the second power transistor 124 performing the sequence of second switching cycles 520, DC link capacitor 102 may discharge through the discharge current pathway 104 from a first voltage to a second voltage even though there are only brief periods of overlap between activation phases 512 and activation phases 522. Electrical current discharged by DC link capacitor 102 may traverse the discharge current pathway 104 via parasitic capacitances of first power transistor 122 and second power transistor and during brief periods of time (e.g., at time T1, time T2, time T3, and time T4) when both of first power transistor 122 and second power transistor 124 are activated. Since activation phases 512 and activation phases 522 are interleaved, this may distribute stress equally between first power transistor 122 and second power transistor 124.

In some examples, the maximum current associated with discharge phases 536, 4538 in the example of third timeseries plot 500 where there are very brief regions of overlap between activation phases of power transistors 122, 124 is greater than the maximum current associated with discharge phases 436, 438 in the example of plot 400 of FIG. 4 where there are no regions of overlap between activation phases of power transistors 122, 124. This is because electrical current is able to flow more freely through discharge current pathway 104 when activation phases of first power transistor 122 transition immediately to activation phases of second power transistor 124 as compared with examples where time gaps exist between activation phases of first power transistor 122 and second power transistor 124.

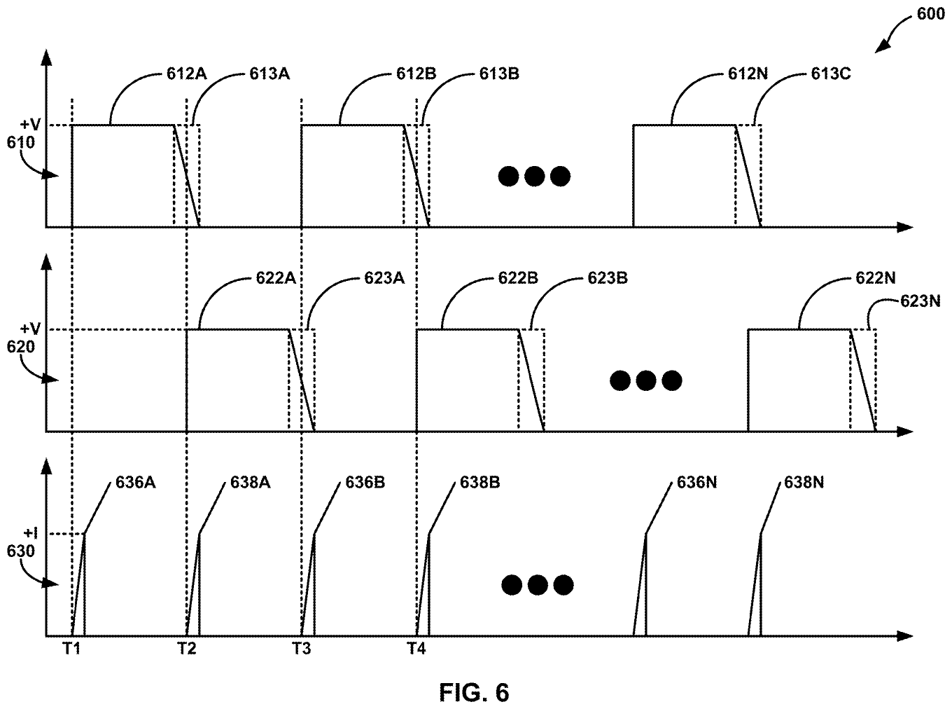

FIG. 6 is a plot diagram illustrating a fourth timeseries plot 600 of a sequence of first switching cycles 610, a sequence of second switching cycles 620, and a sequence of discharge phases 630, in accordance with this disclosure. As seen in FIG. 6, the sequence of first switching cycles 610 includes a set of activation phases 612A-612N (collectively, “activation phases 612”). Each activation phase of activation phases 612 includes a soft turn off phase of soft turn off phases 613A-613N (collectively, “soft turn off phases 613”). The sequence of second switching cycles 620 includes a set of activation phases 622A-622N (collectively, “activation phases 622”). Each activation phase of activation phases 622 includes a soft turn off phase of soft turn off phases 623A-623N (collectively, “soft turn off phases 623”). The sequence of discharge phases 630 may include discharge phases 636A-636N (collectively, “discharge phases 636”) and discharge phases 638A-638N (collectively, “discharge phases 638”).

In some examples, first power transistor 122 of FIG. 1 is configured to perform the sequence of first switching cycles 610. Second power transistor 124 of FIG. 1 may be configured to perform the sequence of second switching cycles 620. In the sequence of first switching cycles 610, first power transistor 122 may be turned on and operating in the saturation region during activation phases 612. In some examples, a duration of each activation phase of activation phases 612 may be substantially the same as a duration of each other activation phase of activation phases 612. First power transistor 122 may be turned off and operating in the cut-off region during periods of time between activation phases (e.g., between activation phase 612A and activation phase 612B). In the sequence of second switching cycles 620, second power transistor 124 may be turned on and operating in the saturation region during activation phases 622. In some examples, a duration of each activation phase of activation phases 622 may be substantially the same as a duration of each other activation phase of activation phases 622. Second power transistor 124 may be turned off and operating in the cut-off region during periods of time between activation phases (e.g., between activation phase 624A and activation phase 624B).

In some examples, first power transistor 122 and second power transistor 124 may be configured to perform a soft turn on or a hard turn on when transitioning from a deactivation phase to an activation phase. A hard turn on involves a faster transition from a deactivation phase to an activation phase. For example, a hard turn on occurs at time T1 when first power transistor 122 transitions from a deactivation phase to activation phase 612A, a hard turn on occurs at time T2 when second power transistor 124 transitions from a deactivation phase to activation phase 622A, and so on. A soft turn on involves a slower transition from a deactivation phase to an activation phase. For example, during a soft turn on, first power transistor 122 and/or second power transistor 124 might not promptly activate in an instant as occurs for the hard turn on phases at time T1, time T2, time T3, and time T4. In some examples, first power transistor 122 and second power transistor 124 may include two separate gate input pins, one gate input pin for a hard turn on and one gate input pin for a soft turn on.

First power transistor 122 and second power transistor 124 may be configured to perform a soft turn off or a hard turn off when transitioning from an activation phase to a deactivation phase. A hard turn off involves a faster transition from an activation phase to a deactivation phase. A soft turn off involves a slower transition from an activation phase to a deactivation phase. For example, during a soft turn off, first power transistor 122 and/or second power transistor 124 might not promptly deactivate in an instant. For example, first power transistor 122 takes time to transition from activation phase 612A to a deactivation phase during soft turn off phase 613A, first power transistor 122 takes time to transition from activation phase 612B to a deactivation phase during soft turn off phase 613B, and so on. First power transistor 122 and second power transistor 124 may include two separate gate input pins, one gate input pin for a hard turn off and one gate input pin for a soft turn off.

First power transistor 122 and second power transistor 124 may, in some examples, each include a single gate input pin for receiving a control signal from a gate driver. In some examples, first gate driver circuit 142 may include two output pins, one output pin for controlling first power transistor 122 to perform a hard turn off and/or a hard turn on and one output pin for controlling first power transistor 122 to perform a hard turn off and/or a hard turn on. In some examples, second gate driver circuit 144 may include two output pins, one output pin for controlling second power transistor 124 to perform a hard turn off and/or a hard turn on and one output pin for controlling second power transistor 124 to perform a hard turn off and/or a hard turn on. In these examples, both output pins of first gate driver circuit 142 may output to the single gate input pin of first power transistor 122 and both output pins of second gate driver circuit 144 may output to the single gate input pin of second power transistor 124.

First power transistor 122 and second power transistor 124 may operate in the non-linear mode when performing the sequence of first switching cycles 610 and the sequence of second switching cycles 620, respectively. That is, first power transistor 122 may perform the sequence of first switching cycles 610 and second power transistor 124 may perform the sequence of second switching cycles 620 by alternating between being fully turned on and being fully turned off. In some examples, a gate voltage applied to the gate terminal of first power transistor 122 during activation phases 612 (+V) exceeds a threshold gate voltage so that the first power transistor 122 operates in the non-linear mode. In some examples, a gate voltage applied to the gate terminal of second power transistor 124 during activation phases 622 and (+V) exceeds the threshold gate voltage so that the second power transistor 124 operates in the non-linear mode.

As seen in FIG. 6, activation phase 622A begins at time T2 with a hard turn on, and T2 is in a middle of soft turn off phase 613A of activation phase 612A. This means that first power transistor 122 is in the process of turning off when second power transistor 124 abruptly turns on. This means that activation phase 622A overlaps with a latter portion of the soft turn off phase 613A of activation phase 612A. This means that DC link capacitor 102 may discharge through discharge current pathway 104 across first power transistor 122 and second power transistor 124 after time T2 during the latter portion of the soft turn off phase 613A of activation phase 612A. During the latter portion of each of activation phases 612, there may be a period where both of first power transistor 122 and second power transistor 124 are activated before first power transistor 122 completes a soft turn off phase. This is also the case for second power transistor 124. During the latter portion of each of activation phases 622, there may be a period where both of first power transistor 122 and second power transistor 124 are activated before second power transistor 124 completes a soft turn off phase.

Even though in the example of fourth timeseries plot 600 there are brief periods of overlap between soft turn off phases 613 of activation phases 612 and activation phases 622, DC link capacitor 102 may still discharge through discharge current pathway 104 via parasitic capacitances of first power transistor 122 and second power transistor 124. For example, a parasitic capacitance of first power transistor 122 may charge even when one or both of first power transistor 122 and second power transistor 124 is deactivated. The parasitic capacitance of first power transistor 122 may discharge to charge a parasitic capacitance of second power transistor 124 even when one or both of first power transistor 122 and second power transistor 124 is deactivated. The parasitic capacitance of second power transistor 124 may discharge to complete discharge current pathway 104 even when one or both of first power transistor 122 and second power transistor 124 is deactivated. That is, electrical current from DC link capacitor 102 may traverse the discharge current pathway 104 by flowing freely through discharge current pathway 104 when both of first power transistor 122 and second power transistor 124 are turned on and by transferring through parasitic capacitances of first power transistor 122 and second power transistor 124.

An electrical current through discharge current pathway 104 may increase to a maximum current (+I) over a period of time following a start of each activation phase of activation phases 612. For example, the electrical current through discharge current pathway 104 increases to the maximum current over the discharge phase 636A following the start of activation phase 612A at time T1, the electrical current through discharge current pathway 104 increases to the maximum current over the discharge phase 636B following the start of activation phase 612B at time T3, and so on. Furthermore, an electrical current through discharge current pathway 104 may increase to the maximum current over a period of time following a start of each activation phase of activation phases 622. For example, the electrical current through discharge current pathway 104 increases to the maximum current over the discharge phase 638A following the start of activation phase 622A at time T2, the electrical current through discharge current pathway 104 increases to the maximum current over the discharge phase 638B following the start of activation phase 622B at time T4, and so on.

By performing soft turn offs to end activation phases, first power transistor 122 and second power transistor 124 may allow for brief periods where both first power transistor 122 and second power transistor 124 are activated without placing undue stress on first power transistor 122 and second power transistor 124. Stress may be distributed evenly between first power transistor 122 and second power transistor 124, because activation phases 612 and activation phases 622 are interleaved. Furthermore, by performing soft turn offs to end activation phases, first power transistor 122 and second power transistor 124 may prevent overvoltage events that occur when hard turn offs are used.

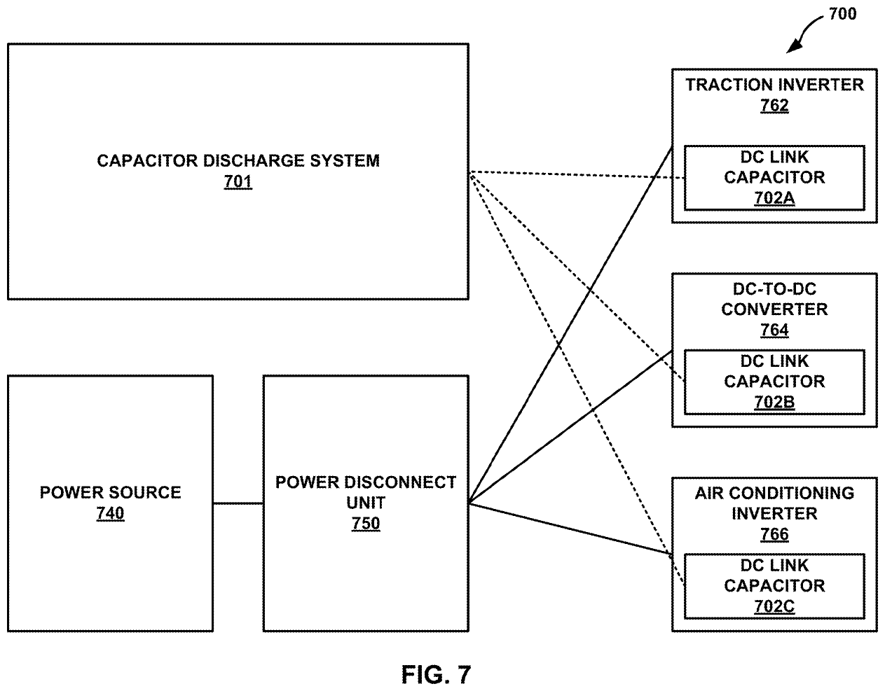

FIG. 7 is a block diagram illustrating an example system 700 for disconnecting power to one or more electrical components and discharging DC link capacitors, in accordance with this disclosure. System 700 includes capacitor discharge system 701, DC link capacitors 702A-702C (collectively, “DC link capacitors 702”), power source 740, power disconnect unit 750, traction inverter 762, DC-to-DC converter 764, and air conditioning inverter 766. As seen in FIG. 7, traction inverter 762 includes DC link capacitor 702A, DC-to-DC converter 764 includes DC link capacitor 702B, and air conditioning inverter 766 includes DC link capacitor.

Capacitor discharge system 701 may include one or more power transistors, gate driver circuits, controllers, or any combination thereof for discharging DC link capacitors 702. DC link capacitor 102 of FIG. 1 and DC link capacitor 202 of FIG. 2 may be examples of any one of DC link capacitor 702A, DC link capacitor 702B, and DC link capacitor 702C. Power source 7490 may supply power to traction inverter 762, DC-to-DC converter 764, and air conditioning inverter 766. Power disconnect unit 750 may disconnect power source 740 from one or more of traction inverter 762, DC-to-DC converter 764, and air conditioning inverter 766 in response to one or more failure conditions or one or more normal operating conditions. Capacitor discharge system 701 may discharge one or more of DC link capacitor 702A, DC link capacitor 702B, and DC link capacitor 702C in response to an electrical component corresponding to the DC link capacitor being disconnected by power disconnect unit 750.

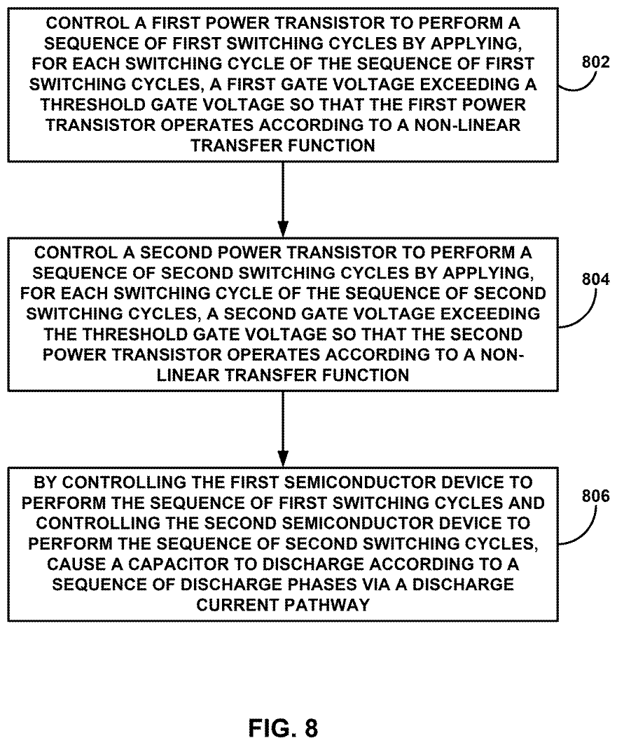

FIG. 8 is a flow diagram illustrating an example operation for using power transistor to cause a DC link capacitor to discharge, in accordance with one or more techniques of this disclosure. FIG. 8 is described with respect to system 100 of FIG. 1. However, the techniques of FIG. 8 may be performed by different components of system 100 or by additional or alternative systems.

Controller 110 is configured to control first power transistor 122 to perform a sequence of first switching cycles by applying, for each switching cycle of the sequence of first switching cycles, a first gate voltage exceeding a threshold gate voltage so that first power transistor 122 operates according to a non-linear transfer function (802). For example, first power transistor 122 may operate in the non-linear mode such that first power transistor alternates between activation phases during which first power transistor 122 operates in the saturation operation region and deactivation phases during which first power transistor 122 operates in the cut-off operation region. First power transistor 122 may be configured to freely conduct current when operating in the saturation operation region.

Controller 110 is configured to control second power transistor 124 to perform a sequence of second switching cycles by applying, for each switching cycle of the sequence of second switching cycles, a second gate voltage exceeding a threshold gate voltage so that second power transistor 124 operates according to a non-linear transfer function (802). For example, second power transistor 124 may operate in the non-linear mode such that first power transistor alternates between activation phases during which second power transistor 124 operates in the saturation operation region and deactivation phases during which second power transistor 124 operates in the cut-off operation region. second power transistor 124 may be configured to freely conduct current when operating in the saturation operation region.

By controlling the first power transistor 122 to perform the sequence of first switching cycles and controlling the second power transistor 124 to perform the sequence of second switching cycles, controller 110 is configured to cause DC link capacitor 102 to discharge according to a sequence of discharge phases via discharge current pathway 104 (806). In some examples, electrical current may discharge from DC link capacitor 102 during each discharge phase of the sequence of discharge phases. Current may discharge freely through discharge current pathway 104 when both of first power transistor 122 and second power transistor 124 are turned on. Additionally, or alternatively, current may discharge through current pathway 104 via parasitic capacitances of first power transistor 122 and second power transistor 124.

The following numbered clauses may demonstrate one or more aspects of the disclosure.

Clause 1: A circuit includes a first power transistor comprising a first gate terminal and a second power transistor includes a second gate terminal. The second power transistor is connected in series with the first power transistor. A capacitor, the first power transistor, and the second power transistor are located on a discharge current pathway. The circuit also includes a controller configured to control the first power transistor to perform a sequence of first switching cycles by applying, for each switching cycle of the sequence of first switching cycles, a first gate voltage to the first gate terminal, the first gate voltage exceeding a threshold gate voltage so that the first power transistor operates according to a non-linear transfer function and control the second power transistor to perform a sequence of second switching cycles by applying, for each switching cycle of the sequence of second switching cycles, a second gate voltage to the second gate terminal, the second gate voltage exceeding the threshold gate voltage so that the second power transistor operates according to the non-linear transfer function. By controlling the first power transistor to perform the sequence of first switching cycles and controlling the second power transistor to perform the sequence of second switching cycles, the controller is configured to cause the capacitor to discharge according to a sequence of discharge phases via the discharge current pathway.

Clause 2: The circuit of clause 1, wherein to cause the capacitor to discharge according to the sequence of discharge phases, the controller is configured to cause, for each discharge phase of the sequence of discharge phases, electrical current to flow from the capacitor via the discharge current pathway.

Clause 3: The circuit of any of clauses 1-2, wherein to cause the capacitor to discharge according to the sequence of discharge phases, the controller is configured to cause a voltage of the capacitor to discharge from a first voltage value to a second voltage value, each discharge phase of the sequence of discharge phases decreasing the voltage of the capacitor until the voltage of the capacitor is equal to the second voltage value.

Clause 4: The circuit of clause 3, further comprising a voltage sensor configured to generate a voltage signal indicating the voltage of the capacitor, and wherein the controller or safety logic is configured to: determine, based on the voltage signal, that the voltage of the capacitor is equal to the second voltage value; control the first power transistor to cease the sequence of first switching cycles based on determining that the voltage of the capacitor is equal to the second voltage value; and control the second power transistor to cease the sequence of second switching cycles based on determining that the voltage of the capacitor is equal to the second voltage value.

Clause 5: The circuit of any of clauses 1-4, wherein the controller is configured to: control the first power transistor to cease the sequence of first switching cycles when a period of time elapses; and control the second power transistor to cease the sequence of second switching cycles when the period of time elapses.

Clause 6: The circuit of any of clauses 1-5, wherein to cause the capacitor to discharge according to the sequence of discharge phases, the controller is configured to, for each discharge phase of the sequence of discharge phases: cause electrical current to flow from the capacitor across the first power transistor and the second power transistor in response to both of the first power transistor and the second power transistor being activated; and prevent electrical current from flowing from the capacitor across the first power transistor and the second power transistor in response to one or both of the first power transistor and the second power transistor being deactivated.

Clause 7: The circuit of any of clauses 1-6, wherein to cause the capacitor to discharge according to the sequence of discharge phases, the controller is configured to, for each discharge phase of the sequence of discharge phases: cause electrical current from the capacitor to charge a parasitic capacitance of the first power transistor; cause the parasitic capacitance of the first power transistor to discharge to charge a parasitic capacitance of the second power transistor; and cause the parasitic capacitance of the second power transistor to discharge.

Clause 8: The circuit of clause 7, wherein to cause the capacitor to discharge according to the sequence of discharge phases, the controller is further configured to, for each discharge phase of the sequence of discharge phases, cause electrical current to flow from the capacitor across the first power transistor and the second power transistor in response to both of the first power transistor and the second power transistor being activated.

Clause 9: The circuit of any of clauses 1-8, wherein each first switching cycle of the sequence of first switching cycles comprises a first activation phase and a first deactivation phase, wherein each second switching cycle of the sequence of second switching cycles comprises a second activation phase and a second deactivation phase, and wherein each discharge phase of the sequence of discharge phases corresponds to a combination of a first activation phase of a first switching cycle of the sequence of first switching cycles and a second activation phase of a second switching cycle of the sequence of second switching cycles.

Clause 10: The circuit of any of clauses 1-9, wherein the sequence of first switching cycles includes a first plurality of short activation phases and a first plurality of long activation phases interleaved with the first plurality of short activation phases, wherein a duration of each short activation phase of the first plurality of short activation phases is shorter than a duration of each long activation phase of the first plurality of long activation phases, wherein the sequence of second switching cycles includes a second plurality of short activation phases and a second plurality of long activation phases interleaved with the second plurality of short activation phases, wherein a duration of each short activation phase of the second plurality of short activation phases is shorter than a duration of each long activation phase of the second plurality of long activation phases, and wherein each discharge phase of the sequence of discharge phases corresponds to: a period of overlap between a short activation phase of the first plurality of short activation phases and a long activation phase of the second plurality of long activation phases; or a period of overlap between a short activation phase of the second plurality of short activation phases and a long activation phase of the first plurality of long activation phases.

Clause 11: The circuit of any of clauses 1-10, wherein the sequence of first switching cycles includes a first plurality of activation phases, wherein the sequence of second switching cycles includes a second plurality of activation phases interleaved with the first plurality of activation phases such that each activation phase of the second plurality of activation phases does not overlap with any of the first plurality of activation phases, and wherein each discharge phase of the sequence of discharge phases corresponds to: a period of time following a start of an activation phase of the first plurality of activation phases; or a period of time following a start of an activation phase of the second plurality of activation phases.

Clause 12: The circuit of any of clauses 1-11, wherein the sequence of first switching cycles includes a first plurality of activation phases, each activation phase of the first plurality of activation phases ending in a first soft turn off phase where the first gate voltage decreases over the first soft turn off phase, wherein the sequence of second switching cycles includes a second plurality of activation phases, each activation phase of the second plurality of activation phases ending in a second soft turn off phase where the second gate voltage decreases over the second soft turn off phase, and wherein each discharge phase of the sequence of discharge phases corresponds to: a period of overlap between the first soft turn off phase of an activation phase of the first plurality of activation phases and an activation phase of the second plurality of activation phases; or a period of overlap between the second soft turn off phase of an activation phase of the second plurality of activation phases and tan activation phase of the first plurality of activation phases.

Clause 13: The circuit of any of clauses 1-12, wherein the controller is configured to: identify one or more failure conditions prompting a discharge operation to cause the capacitor to discharge; and initiate the discharge operation based on identifying the one or more failure conditions, wherein the discharge operation includes the first power transistor performing the sequence of first switching cycles and the second power transistor performing the sequence of second switching cycles.

Clause 14: The circuit of any of clauses 1-13, wherein the controller is configured to: identify one or more standard operating modes prompting a discharge operation to cause the capacitor to discharge; and initiate the discharge operation based on identifying the one or more standard operating modes, wherein the discharge operation includes the first power transistor performing the sequence of first switching cycles and the second power transistor performing the sequence of second switching cycles.

Clause 15: The circuit of any of clauses 1-14, wherein the capacitor comprises a DC link capacitor connected to an inverter circuit for an electrical motor of a vehicle.

Clause 16: A method including controlling, by a controller, a first power transistor comprising a first gate terminal to perform a sequence of first switching cycles by applying, for each switching cycle of the sequence of first switching cycles, a first gate voltage to the first gate terminal, the first gate voltage exceeding a threshold gate voltage so that the first power transistor operates according to a non-linear transfer function; and controlling, by the controller, a second power transistor comprising a second gate terminal to perform a sequence of second switching cycles by applying, for each switching cycle of the sequence of second switching cycles, a second gate voltage to the second gate terminal, the second gate voltage exceeding the threshold gate voltage so that the second power transistor operates according to the non-linear transfer function, wherein the second power transistor is connected in series with the first power transistor, and wherein a capacitor, the first power transistor, and the second power transistor are located on a discharge current pathway. By controlling the first power transistor to perform the sequence of first switching cycles and controlling the second power transistor to perform the sequence of second switching cycles, the method comprises causing the capacitor to discharge according to a sequence of discharge phases via the discharge current pathway.

Clause 17: The method of clause 16, wherein causing the capacitor to discharge according to the sequence of discharge phases comprises causing, for each discharge phase of the sequence of discharge phases, electrical current to flow from the capacitor via the discharge current pathway.

Clause 18: The method of any of clauses 16-17, wherein causing the capacitor to discharge according to the sequence of discharge phases comprises causing a voltage of the capacitor to discharge from a first voltage value to a second voltage value, each discharge phase of the sequence of discharge phases decreasing the voltage of the capacitor until the voltage of the capacitor is equal to the second voltage value.

Clause 19: The method of any of clauses 16-18, wherein causing the capacitor to discharge according to the sequence of discharge phases comprises, for each discharge phase of the sequence of discharge phases: causing, by the controller, electrical current to flow from the capacitor across the first power transistor and the second power transistor in response to both of the first power transistor and the second power transistor being activated; and preventing, by the controller, electrical current from flowing from the capacitor across the first power transistor and the second power transistor in response to one or both of the first power transistor and the second power transistor being deactivated.

Clause 20: The method of any of clauses 16-19, wherein causing the capacitor to discharge according to the sequence of discharge phases comprises, for each discharge phase of the sequence of discharge phases: causing, by the controller, electrical current from the capacitor to charge a parasitic capacitance of the first power transistor; causing, by the controller, the parasitic capacitance of the first power transistor to discharge to charge a parasitic capacitance of the second power transistor; and causing, by the controller, the parasitic capacitance of the second power transistor to discharge.

Clause 21: The method of clause 20, wherein causing the capacitor to discharge according to the sequence of discharge phases comprises, by the controller for each discharge phase of the sequence of discharge phases, causing electrical current to flow from the capacitor across the first power transistor and the second power transistor in response to both of the first power transistor and the second power transistor being activated.

Clause 22: A system includes a capacitor, a first power transistor comprising a first gate terminal, and a second power transistor comprising a second gate terminal. The second power transistor is connected in series with the first power transistor. The capacitor, the first power transistor, and the second power transistor are located on a discharge current pathway. The system also includes a controller configured to: control the first power transistor to perform a sequence of first switching cycles by applying, for each switching cycle of the sequence of first switching cycles, a first gate voltage to the first gate terminal, the first gate voltage exceeding a threshold gate voltage so that the first power transistor operates according to a non-linear transfer function; and control the second power transistor to perform a sequence of second switching cycles by applying, for each switching cycle of the sequence of second switching cycles, a second gate voltage to the second gate terminal, the second gate voltage exceeding the threshold gate voltage so that the second power transistor operates according to the non-linear transfer function. By controlling the first power transistor to perform the sequence of first switching cycles and controlling the second power transistor to perform the sequence of second switching cycles, the system is configured to cause the capacitor to discharge according to a sequence of discharge phases via the discharge current pathway.

Clause 23: The system of clause 22, further comprising: a first gate driver circuit; and a second gate driver circuit, wherein to control the first power transistor to perform the sequence of first switching cycles, the controller is configured to output a first control signal to the first gate driver circuit to cause the first gate driver circuit to perform the sequence of first switching cycles, and wherein to control the second power transistor to perform the sequence of second switching cycles, the controller is configured to output a second control signal to the second gate driver circuit to cause the second gate driver circuit to perform the sequence of second switching cycles.

The techniques described in this disclosure may be implemented, at least in part, in hardware, software, firmware or any combination thereof. For example, various aspects of the described techniques may be implemented within one or more processors, including one or more microprocessors, DSPs, ASICs, FPGAs, or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include RAM, ROM, programmable read only memory (PROM), erasable programmable read only memory (EPROM), EEPROM, flash memory, a hard disk, a compact disk-read only memory (CD-ROM), a floppy disk, a cassette, magnetic media, optical media, or other computer readable media.

Various examples have been described. These and other examples are within the scope of the following claims.

What is claimed is:

1. A circuit comprising:
a first power transistor comprising a first gate terminal; and
a second power transistor comprising a second gate terminal, the second power transistor connected in series with the first power transistor, wherein a capacitor, the first power transistor, and the second power transistor are located on a discharge current pathway; and
a controller configured to:
control the first power transistor to perform a sequence of first switching cycles by applying, for each switching cycle of the sequence of first switching cycles, a first gate voltage to the first gate terminal, the first gate voltage exceeding a threshold gate voltage so that the first power transistor operates according to a non-linear transfer function;
control the second power transistor to perform a sequence of second switching cycles by applying, for each switching cycle of the sequence of second switching cycles, a second gate voltage to the second gate terminal, the second gate voltage exceeding the threshold gate voltage so that the second power transistor operates according to the non-linear transfer function; and
by controlling the first power transistor to perform the sequence of first switching cycles and controlling the second power transistor to perform the sequence of second switching cycles, cause the capacitor to discharge according to a sequence of discharge phases via the discharge current pathway.

2. The circuit of claim 1, wherein to cause the capacitor to discharge according to the sequence of discharge phases, the controller is configured to cause, for each discharge phase of the sequence of discharge phases, electrical current to flow from the capacitor via the discharge current pathway.

3. The circuit of claim 1, wherein to cause the capacitor to discharge according to the sequence of discharge phases, the controller is configured to cause a voltage of the capacitor to discharge from a first voltage value to a second voltage value, each discharge phase of the sequence of discharge phases decreasing the voltage of the capacitor until the voltage of the capacitor is equal to the second voltage value.

4. The circuit of claim 3, further comprising a voltage sensor configured to generate a voltage signal indicating the voltage of the capacitor, and wherein the controller or safety logic is configured to:
determine, based on the voltage signal, that the voltage of the capacitor is equal to the second voltage value;
control the first power transistor to cease the sequence of first switching cycles based on determining that the voltage of the capacitor is equal to the second voltage value; and
control the second power transistor to cease the sequence of second switching cycles based on determining that the voltage of the capacitor is equal to the second voltage value.

5. The circuit of claim 1, wherein the controller is configured to:
control the first power transistor to cease the sequence of first switching cycles when a period of time elapses; and
control the second power transistor to cease the sequence of second switching cycles when the period of time elapses.

6. The circuit of claim 1, wherein to cause the capacitor to discharge according to the sequence of discharge phases, the controller is configured to, for each discharge phase of the sequence of discharge phases:
cause electrical current to flow from the capacitor across the first power transistor and the second power transistor in response to both of the first power transistor and the second power transistor being activated; and
prevent electrical current from flowing from the capacitor across the first power transistor and the second power transistor in response to one or both of the first power transistor and the second power transistor being deactivated.

7. The circuit of claim 1, wherein to cause the capacitor to discharge according to the sequence of discharge phases, the controller is configured to, for each discharge phase of the sequence of discharge phases:
cause electrical current from the capacitor to charge a parasitic capacitance of the first power transistor;
cause the parasitic capacitance of the first power transistor to discharge to charge a parasitic capacitance of the second power transistor; and
cause the parasitic capacitance of the second power transistor to discharge.

8. The circuit of claim 7, wherein to cause the capacitor to discharge according to the sequence of discharge phases, the controller is further configured to, for each discharge phase of the sequence of discharge phases, cause electrical current to flow from the capacitor across the first power transistor and the second power transistor in response to both of the first power transistor and the second power transistor being activated.

9. The circuit of claim 1,
wherein each first switching cycle of the sequence of first switching cycles comprises a first activation phase and a first deactivation phase,
wherein each second switching cycle of the sequence of second switching cycles comprises a second activation phase and a second deactivation phase, and
wherein each discharge phase of the sequence of discharge phases corresponds to a combination of a first activation phase of a first switching cycle of the sequence of first switching cycles and a second activation phase of a second switching cycle of the sequence of second switching cycles.

10. The circuit of claim 1,
wherein the sequence of first switching cycles includes a first plurality of short activation phases and a first plurality of long activation phases interleaved with the first plurality of short activation phases, wherein a duration of each short activation phase of the first plurality of short activation phases is shorter than a duration of each long activation phase of the first plurality of long activation phases,
wherein the sequence of second switching cycles includes a second plurality of short activation phases and a second plurality of long activation phases interleaved with the second plurality of short activation phases, wherein a duration of each short activation phase of the second plurality of short activation phases is shorter than a duration of each long activation phase of the second plurality of long activation phases, and
wherein each discharge phase of the sequence of discharge phases corresponds to:
a period of overlap between a short activation phase of the first plurality of short activation phases and a long activation phase of the second plurality of long activation phases; or
a period of overlap between a short activation phase of the second plurality of short activation phases and a long activation phase of the first plurality of long activation phases.

11. The circuit of claim 1,
wherein the sequence of first switching cycles includes a first plurality of activation phases,
wherein the sequence of second switching cycles includes a second plurality of activation phases interleaved with the first plurality of activation phases such that each activation phase of the second plurality of activation phases does not overlap with any of the first plurality of activation phases, and
wherein each discharge phase of the sequence of discharge phases corresponds to:
a period of time following a start of an activation phase of the first plurality of activation phases; or
a period of time following a start of an activation phase of the second plurality of activation phases.

12. The circuit of claim 1,
wherein the sequence of first switching cycles includes a first plurality of activation phases, each activation phase of the first plurality of activation phases ending in a first soft turn off phase where the first gate voltage decreases over the first soft turn off phase,
wherein the sequence of second switching cycles includes a second plurality of activation phases, each activation phase of the second plurality of activation phases ending in a second soft turn off phase where the second gate voltage decreases over the second soft turn off phase, and
wherein each discharge phase of the sequence of discharge phases corresponds to:
a period of overlap between the first soft turn off phase of an activation phase of the first plurality of activation phases and an activation phase of the second plurality of activation phases; or
a period of overlap between the second soft turn off phase of an activation phase of the second plurality of activation phases and tan activation phase of the first plurality of activation phases.

13. The circuit of claim 1, wherein the controller is configured to:
identify one or more failure conditions prompting a discharge operation to cause the capacitor to discharge; and
initiate the discharge operation based on identifying the one or more failure conditions, wherein the discharge operation includes the first power transistor performing the sequence of first switching cycles and the second power transistor performing the sequence of second switching cycles.

14. The circuit of claim 1, wherein the controller is configured to:
identify one or more standard operating modes prompting a discharge operation to cause the capacitor to discharge; and
initiate the discharge operation based on identifying the one or more standard operating modes, wherein the discharge operation includes the first power transistor performing the sequence of first switching cycles and the second power transistor performing the sequence of second switching cycles.

15. The circuit of claim 1, wherein the capacitor comprises a direct current (DC) link capacitor connected to an inverter circuit for an electrical motor of a vehicle.

16. A method comprising:
controlling, by a controller, a first power transistor comprising a first gate terminal to perform a sequence of first switching cycles by applying, for each switching cycle of the sequence of first switching cycles, a first gate voltage to the first gate terminal, the first gate voltage exceeding a threshold gate voltage so that the first power transistor operates according to a non-linear transfer function; and
controlling, by the controller, a second power transistor comprising a second gate terminal to perform a sequence of second switching cycles by applying, for each switching cycle of the sequence of second switching cycles, a second gate voltage to the second gate terminal, the second gate voltage exceeding the threshold gate voltage so that the second power transistor operates according to the non-linear transfer function, wherein the second power transistor is connected in series with the first power transistor, and wherein a capacitor, the first power transistor, and the second power transistor are located on a discharge current pathway; and
by controlling the first power transistor to perform the sequence of first switching cycles and controlling the second power transistor to perform the sequence of second switching cycles, causing the capacitor to discharge according to a sequence of discharge phases via the discharge current pathway.

17. The method of claim 16, wherein causing the capacitor to discharge according to the sequence of discharge phases comprises causing, for each discharge phase of the sequence of discharge phases, electrical current to flow from the capacitor via the discharge current pathway.

18. The method of claim 16, wherein causing the capacitor to discharge according to the sequence of discharge phases comprises causing a voltage of the capacitor to discharge from a first voltage value to a second voltage value, each discharge phase of the sequence of discharge phases decreasing the voltage of the capacitor until the voltage of the capacitor is equal to the second voltage value.

19. The method of claim 16, wherein causing the capacitor to discharge according to the sequence of discharge phases comprises, for each discharge phase of the sequence of discharge phases:
causing, by the controller, electrical current to flow from the capacitor across the first power transistor and the second power transistor in response to both of the first power transistor and the second power transistor being activated; and
preventing, by the controller, electrical current from flowing from the capacitor across the first power transistor and the second power transistor in response to one or both of the first power transistor and the second power transistor being deactivated.

20. The method of claim 16, wherein causing the capacitor to discharge according to the sequence of discharge phases comprises, for each discharge phase of the sequence of discharge phases:
causing, by the controller, electrical current from the capacitor to charge a parasitic capacitance of the first power transistor;
causing, by the controller, the parasitic capacitance of the first power transistor to discharge to charge a parasitic capacitance of the second power transistor; and
causing, by the controller, the parasitic capacitance of the second power transistor to discharge.

21. The method of claim 20, wherein causing the capacitor to discharge according to the sequence of discharge phases comprises, by the controller for each discharge phase of the sequence of discharge phases, causing electrical current to flow from the capacitor across the first power transistor and the second power transistor in response to both of the first power transistor and the second power transistor being activated.

22. A system comprising:
a capacitor;
a first power transistor comprising a first gate terminal; and
a second power transistor comprising a second gate terminal, the second power transistor connected in series with the first power transistor, wherein the capacitor, the first power transistor, and the second power transistor are located on a discharge current pathway; and
a controller configured to:
control the first power transistor to perform a sequence of first switching cycles by applying, for each switching cycle of the sequence of first switching cycles, a first gate voltage to the first gate terminal, the first gate voltage exceeding a threshold gate voltage so that the first power transistor operates according to a non-linear transfer function;
control the second power transistor to perform a sequence of second switching cycles by applying, for each switching cycle of the sequence of second switching cycles, a second gate voltage to the second gate terminal, the second gate voltage exceeding the threshold gate voltage so that the second power transistor operates according to the non-linear transfer function; and
by controlling the first power transistor to perform the sequence of first switching cycles and controlling the second power transistor to perform the sequence of second switching cycles, cause the capacitor to discharge according to a sequence of discharge phases via the discharge current pathway.

23. The system of claim 22, further comprising:
a first gate driver circuit; and
a second gate driver circuit,
wherein to control the first power transistor to perform the sequence of first switching cycles, the controller is configured to output a first control signal to the first gate driver circuit to cause the first gate driver circuit to perform the sequence of first switching cycles, and
wherein to control the second power transistor to perform the sequence of second switching cycles, the controller is configured to output a second control signal to the second gate driver circuit to cause the second gate driver circuit to perform the sequence of second switching cycles.
